(19) United States
(12) Patent Application Publication
(10) Pub. No.: US 2017/0075372 A1
(43) Pub. Date: Mar. 16, 2017

(54) ENERGY-AMOUNT ESTIMATION DEVICE, ENERGY-AMOUNT ESTIMATION METHOD, AND RECORDING MEDIUM

(71) Applicant: NEC Corporation, Minato-ku, Tokyo (JP)

(72) Inventors: Yosuke MOTOHASHI, Tokyo (JP); Ryohei FUJIMAKI, Tokyo (JP); Satoshi MORINAGA, Tokyo (JP); Riki ETO, Tokyo (JP)

(73) Assignee: NEC Corporation, Minato-ku, Tokyo (JP)

(21) Appl. No.: 15/125,394

(22) PCT Filed: Feb. 27, 2015
(86) PCT No.: PCT/JP2015/001022

§ 371 Date: Sep. 12, 2016

Related U.S. Application Data
(60) Provisional application No. 61/971,592, filed on Mar. 28, 2014.

(51) Int. Cl. G05F 1/66; G05B 13/02

(52) U.S. Cl. CPC G05F 1/66; G05B 13/026; G05B 2219/40458

(57) ABSTRACT

An energy-amount estimation device that can predict an energy amount with a high degree of precision is disclosed. Said energy-amount estimation device has a prediction unit that, on the basis of the relationship between energy amount and one or more explanatory variables representing information that can influence said energy amount, predicts an energy amount pertaining to prediction information that indicates a prediction target. The aforementioned relationship is computed on the basis of specific learning information, within learning information in which an objective variable representing the aforementioned energy amount is associated with the one or more explanatory variables, that matches or is similar to the aforementioned prediction information.

The present invention relates to an energy-amount estimation device, an energy-amount estimation method, and recording medium

### BACKGROUND ART

For example, an energy amount consumed in a building varies depending on various factors such as weather and a day of the week. A correlation between a factor, such as weather, and a consumed energy amount is analyzed by using statistical data associated with an observation value, such as weather, and a consumed energy amount when the observation value is observed. Further, an energy amount consumed in the future in a building is estimated (predicted) on the basis of the analysis result.

PTL 1 discloses a technology of specifically predicting an energy amount especially such as an electric-power amount representing an electric-power demand and the like.

PTL 1 discloses an example of a device predicting an electric-power demand on the basis of input data such as a temperature. The device includes, in advance, a plurality of prediction procedures depending on various situations, and a predetermined condition for selecting a prediction procedure to be applied. The device determines whether or not input data is satisfying a predetermined condition, and selects a specific prediction procedure from a plurality of prediction procedures in accordance with the determination result. Subsequently, the device performs prediction related to the data by applying the selected prediction procedure to the input data.

NPL 1 disclose methods for determining the type of observation probability by approximating the complete marginal likelihood function for a mixture model that typifies the latent variable model and, then, maximizing its lower bound (lower limit) as an example of prediction techniques.

### CITATION LIST

### Patent Literature

[PTL 1] Japanese Unexamined Patent Application Publication No. 2013-255390

### Non-Patent Literature

[NPL 1] Ryohei Fujimaki, Satoshi Morinaga: Factorized Asymptotic Bayesian Inference for Mixture Modeling. Proceedings_of_the_fifteenth_international_conference_on_Artificial_Intelligence_and_Statistics (AISTATS), March 2012.

### SUMMARY OF INVENTION

### Technical Problem

In the device disclosed in PTL 1, a predetermined condition is a manually set condition, and therefore is not always a condition improving a degree of prediction accuracy. Additionally, in the device, a predetermined condition needs to be set every time input data are changed. In order to set a predetermined condition achieving a high prediction accuracy, knowledge of input data is required in addition to knowledge of a prediction procedure. Therefore, only an expert having sufficient knowledge is able to construct the device disclosed in PTL 1.

In order to solve the aforementioned problem, one of objects of the present invention is to provide an energy-amount estimation device, an energy-amount estimation method, a recording medium, and the like, being capable of predicting an energy amount.

### Solution to Problem

As an aspect of the present invention, an energy-amount estimation device including:

prediction data input means for inputting prediction data being one or more explanatory variables potentially influencing an energy amount;

component determination means for determining a component used for prediction of the energy amount on the basis of a hierarchical latent structure in which a latent variable is expressed by a hierarchical structure which includes one or more nodes arranged at each level of the hierarchical structure, a path between a node arranged at a first level and a node arranged at a subordinate second level, and components representing a probability model arranged in a node at a lowest level of the hierarchical structure, a gating function model being a basis of determining the path between the nodes constituting the hierarchical latent structure when determining the component, and the prediction data; and

energy-amount prediction means for predicting the energy amount on the basis of the component determined by the component determination means and the prediction data.

In addition, as another aspect of the present invention, an energy-amount estimation method including:

inputting prediction data being one or more explanatory variables potentially influencing an energy amount;

determining a component used for prediction of the energy amount on the basis of a hierarchical latent structure in which a latent variable is expressed by a hierarchical structure which includes one or more nodes arranged at each level of the hierarchical structure, a path between a node arranged at a first level and a node arranged at a subordinate second level, and components representing a probability model arranged in a node at a lowest level of the hierarchical structure, a gating function model being a basis of determining the path between the nodes constituting the hierarchical latent structure when determining the component, and the prediction data; and

predicting the energy amount on the basis of the determined component and the prediction data.

Furthermore, the object is also realized by an energy-amount estimation program, and a computer-readable recording medium which records the program.

### Advantageous Effects of Invention

According to the above-mentioned aspects, an energy-amount can be estimated more accurately.

### BRIEF DESCRIPTION OF DRAWINGS

FIG. 1 is a block diagram illustrating an exemplary configuration of an energy-amount estimation system according to at least one exemplary embodiment of the present invention.

FIG. 2A is a table illustrating an example of information stored in a learning database according to at least one exemplary embodiment of the present invention.

FIG. 2B is a table illustrating an example of information stored in a learning database according to at least one exemplary embodiment of the present invention.

FIG. 2C is a table illustrating an example of information stored in a learning database according to at least one exemplary embodiment of the present invention.

FIG. 2D is a table illustrating an example of information stored in a learning database according to at least one exemplary embodiment of the present invention.

FIG. 2E is a table illustrating an example of information stored in a learning database according to at least one exemplary embodiment of the present invention.

FIG. 2F is a table illustrating an example of information stored in a learning database according to at least one exemplary embodiment of the present invention.

FIG. 3 is a block diagram illustrating an exemplary configuration of a hierarchical latent variable model estimation device according to at least one exemplary embodiment of the present invention.

FIG. 4 is a block diagram illustrating an exemplary configuration of a hierarchical latent variable variational probability computation unit according to at least one exemplary embodiment of the present invention.

FIG. 5 is a block diagram illustrating an exemplary configuration of a gating function model optimization unit according to at least one exemplary embodiment of the present invention.

FIG. 6 is a flowchart illustrating an exemplary operation of a hierarchical latent variable model estimation device according to at least one exemplary embodiment of the present invention.

FIG. 7 is a flowchart illustrating an exemplary operation of a hierarchical latent variable variational probability computation unit according to at least one exemplary embodiment of the present invention.

FIG. 8 is a flowchart illustrating an exemplary operation of a gating function model optimization unit according to at least one exemplary embodiment of the present invention.

FIG. 9 is a block diagram illustrating an exemplary configuration of an energy-amount estimation device according to at least one exemplary embodiment of the present invention.

FIG. 10 is a flowchart illustrating an exemplary operation of an energy-amount estimation device according to at least one exemplary embodiment of the present invention.

FIG. 11 is a block diagram illustrating an exemplary configuration of another hierarchical latent variable model estimation device according to at least one exemplary embodiment of the present invention.

FIG. 12 is a block diagram illustrating an exemplary configuration of a hierarchical latent structure optimization unit according to at least one exemplary embodiment.

FIG. 13 is a flowchart illustrating an exemplary operation of the hierarchical latent variable model estimation device according to at least one exemplary embodiment of the present invention.

FIG. 14 is a flowchart illustrating an exemplary operation of a hierarchical latent structure optimization unit according to at least one exemplary embodiment of the present invention.

FIG. 15 is a block diagram illustrating an exemplary configuration of another gating function model optimization unit according to at least one exemplary embodiment of the present invention.

FIG. 16 is a flowchart illustrating an exemplary operation of a gating function model optimization unit according to at least one exemplary embodiment of the present invention.

FIG. 17 is a block diagram illustrating a basic configuration of another hierarchical latent variable model estimation device according to at least one exemplary embodiment of the present invention.

FIG. 18 is a block diagram illustrating a basic configuration of an energy-amount estimation device according to at least one exemplary embodiment of the present invention.

FIG. 19 is a schematic block diagram illustrating a configuration of a computer according to at least one exemplary embodiment of the present invention.

FIG. 20 is a block diagram illustrating a configuration of an energy-amount estimation device according to a fourth exemplary embodiment of the present invention.

FIG. 21 is a flowchart illustrating a processing flow in an energy-amount estimation device according to a fourth exemplary embodiment.

FIG. 22 is a block diagram illustrating a configuration of an energy-amount estimation device according to a fifth exemplary embodiment of the present invention.

FIG. 23 is a flowchart illustrating a processing flow in an energy-amount estimation device according to a fifth exemplary embodiment.

FIG. 24 is a block diagram illustrating a configuration of an energy-amount estimation device according to a sixth exemplary embodiment of the present invention.

FIG. 25 is a flowchart illustrating a processing flow in an energy-amount estimation device according to a sixth exemplary embodiment.

FIG. 26 is a diagram illustrating an example of gating function models and components generated by the component determination unit according to at least one of the exemplary embodiments of the present invention.

### DESCRIPTION OF EMBODIMENTS

(Applicant's note: Greek alphabet ‘phi’ may appear differently between in the following text and in the following Eqns. due to a constraint of font of a writing software such as Microsoft Word. Even when Geek alphabet ‘phi’ appears differently, the difference in appearance does not mean anything.)

In order to facilitate understanding of the invention, problems to be solved by the present invention will be first described in detail.

There is a problem that, even when the method described in NPL 1 is applied to energy amount prediction, a model selection problem in a model including hierarchical latent variables cannot be solved.

The reason is that the method described in NPL 1 does not take hierarchical latent variables into consideration and, therefore, a computation procedure cannot be self-evidently constructed. Further, the method described in NPL 1 is based on a strong assumption that the method cannot be applied in the presence of hierarchical latent variables, and therefore theoretical justification is lost when the method is simply applied to energy amount prediction.

The inventor of the present invention has come to find out such a problem and to derive a means for solving such a problem. Exemplary embodiments of the present invention capable of solving such a problem will be described in detail below with reference to the drawings.

An energy amount as a prediction target is an energy amount such as an electric-power energy amount, a thermal-energy amount, a hydro-energy amount, a bioenergy amount, a mechanical-energy amount, and a food-energy amount. Further, an energy amount being a prediction target includes not only demand prediction related to an energy amount but also production (supply) prediction related to an energy amount.

An energy amount being a prediction target is an energy amount related to a finite domain (range) such as a building, a region, a country, a ship, and a railcar. Further, in this case, an energy amount may be an energy amount consumed in the finite domain or an energy amount generated in the finite domain.

For convenience of description, it is hereinafter assumed that a finite domain according to respective exemplary embodiments is a building (the aforementioned finite domain is hereinafter referred to as a “building-or-the-like”). However, the finite domain is not limited to a building as described above.

A learning database includes a plurality of pieces of data related to a building-or-the-like and an energy amount.

The hierarchical latent variable model referred to in this description is defined as a probability model having latent variables represented by a hierarchical structure. Components representing probability models are assigned to the nodes at the lowest level of the hierarchical latent variable model. Gating function models for selecting nodes in accordance with input information are allocated to nodes other than the nodes at the lowest level.

Here, a model is a process, a method and so on for estimating the energy amount on the basis of various factors that affect the energy amount.

The hierarchical latent variable model referred to in this description is defined as a probability model having latent variables represented by a hierarchical structure (for example, a tree structure). Components representing probability models are assigned to the nodes at the lowest level of the hierarchical latent variable model. Gating functions (gating function models) as criteria for selecting (determining) nodes in accordance with input information are allocated to nodes (intermediate nodes; to be referred to as “branch nodes” hereinafter, for the sake of convenience in taking a tree structure as an example) other than the nodes at the lowest level.

A process by an energy-amount estimation device and other details will be described hereinafter with reference to a two-level hierarchical latent variable model taken as example. For the sake of descriptive convenience, the hierarchical structure is assumed to be a tree structure. However, in the present invention to be set forth by taking the following exemplary embodiments as an example, the hierarchical structure is not always a tree structure.

When the hierarchical structure is assumed to be a tree structure, course from the root node to a certain node is only one because the tree structure has no loop (cycle). The course (link) from the root node to a certain node in the hierarchical latent structure will be referred to as a “path” hereinafter. Path latent variables are determined by tracing the latent variables for each path. For example, a lowest-level path latent variable is defined as a path latent variable determined for each path from the root node to the node at the lowest level.

The following description assumes that a data sequence xⁿ (n=N) is input. It is assumed that each xⁿ is defined as an M-dimensional multivariate data sequence (xⁿ=x₁ⁿ, . . . , x_{M}ⁿ). The data sequence xⁿ also sometimes serves as an observation variable. A first-level branch latent variable zᵢⁿ, a lowest-level branch latent variable zⱼₗᵢⁿ, and a lowest-level path latent variable zᵢⱼⁿ for the observation variable xⁿ are defined as follows.

zᵢⁿ=1 indicates that a branch of xⁿ input to the root node to the i-th node at the first level takes place. zᵢⁿ=0 indicates that no branch to the i-th node at the first level takes place. zⱼₗᵢⁿ=1 indicates that a branch of xⁿ input to the i-th node at the first level to the j-th node at the second level takes place. zⱼₗᵢⁿ=0 indicates that no branch to the j-th node at the second level takes place when a node is selected based on xⁿ input to the i-th node at the first level. zᵢⱼⁿ=1 indicates that a branch of xⁿ input to a component traced by passing through the i-th node at the first level and the j-th node at the second level takes place. zᵢⱼⁿ=0 indicates that no branch of xⁿ input to a component traced by passing through the i-th node at the first level and the j-th node at the second level takes place.

Since Σᵢzⁱₙ=1, Σⱼzⱼₗᵢⁿ=1, and zᵢⱼⁿ=zᵢⁿ·zⱼₗᵢⁿ are satisfied, we have zᵢⁿ=Σⱼzᵢⱼⁿ. combination of x and the representative value z of the lowest-level path latent variable zᵢⱼⁿ is called a “complete variable.” In contrast to this, x is called an incomplete variable.

Eqn. 1 represents a hierarchical latent variable model joint distribution of depth 2 for a complete variable.

$$p ( {x}^{N} , {z}^{N} \vert M ) = p ( {x}^{N} , {z}_{1 st}^{N} , {z}_{2 nd}^{N} \vert M ) = \int {\prod }_{n = 1}^{N} \{ p ( {z}_{1 st}^{N} \vert β ) {\prod }_{i = 1}^{{K}_{1}} {p ( {z}_{2 nd \vert i}^{n} \vert {β}_{i} )}^{{z}_{i}^{n}} {\prod }_{i = 1}^{{K}_{1}} {\prod }_{j = 1}^{{K}_{2}} {p ( {x}^{n} \vert {φ}_{ij} )}^{{z}_{i}^{n} {z}_{j \vert i}^{n}} \} d θ \qquad ( Eqn . 1 )$$

In other words, P(x, y)=P(x, z₁ₛₜ, z_{2nd}) in Eqn. 1 defines a hierarchical latent variable model joint distribution of depth 2 for a complete variable. In Eqn. 1, z₁ₛₜⁿ is the representative value of zᵢⁿ and z_{2nd}ⁿ is the representative value of zⱼₗᵢⁿ. The variational distribution for the first-level branch latent variable zᵢⁿ is represented as q(zᵢⁿ) and the variational distribution for the lowest-level path latent variable zᵢⱼⁿ is represented as q(zᵢⱼⁿ).

In Eqn. 1, K₁ is the number of nodes in the first level and K₂ is the number of nodes branched from each node at the first level. In this case, a component at the lowest level is expressed as K₁×K₂. Let θ=(β, β₁, . . . , β_{K1}, φ₁, . . . , φ_{K1×K2}) be the model parameter, where β is the branch parameter of the root node, βₖ is the branch parameter of the k-th node at the first level, and φₖ is the observation parameter for the k-th component.

A hierarchical latent variable model of depth 2 will be taken as a specific example hereinafter. However, the hierarchical latent variable model according to at least one exemplary embodiment is not limited to a hierarchical latent variable model of depth 2 and may be defined as a hierarchical latent variable model of depth 1 or 3 or more. In this case, as well as a hierarchical latent variable model of depth 2, Eqn. 1 and Eqns. 2 to 4 (to be described later) need only be derived, thereby implementing an estimation device with a similar configuration.

A distribution having X as a target variable will be described hereinafter. However, the same applies to the case where the observation distribution serves as a conditional model P(Y|X) (Y is the target probability variable), as in regression or classification.

Before a description of exemplary embodiments, the essential difference between an estimation device according to any of these exemplary embodiments and the estimation method for a mixture latent variable model described in NPL 1 will be described below.

The method disclosed in NPL 1 assumes a general mixture model having the latent variable as an indicator for each component. Then, an optimization criterion is derived, as presented in Eqn. 10 of NPL 1. However, given a Fisher information matrix expressed as Eqn. 6 in NPL 1, the method described in NPL 1 postulates that the probability distribution of the latent variable serving as an indicator for each component depends only on the mixture ratio in the mixture model. Therefore, since the components cannot be switched in accordance with input, this optimization criterion is inappropriate.

To solve this problem, it is necessary to set hierarchical latent variables and perform computation involved in accordance with an appropriate optimization criterion, as will be shown in the following exemplary embodiments. The following exemplary embodiments assume that a multi-level singular model for selecting branches at respective branch nodes in accordance with input is used as such an appropriate optimization criterion.

Exemplary embodiments will be described below with reference to the accompanying drawings.

### First Exemplary Embodiment

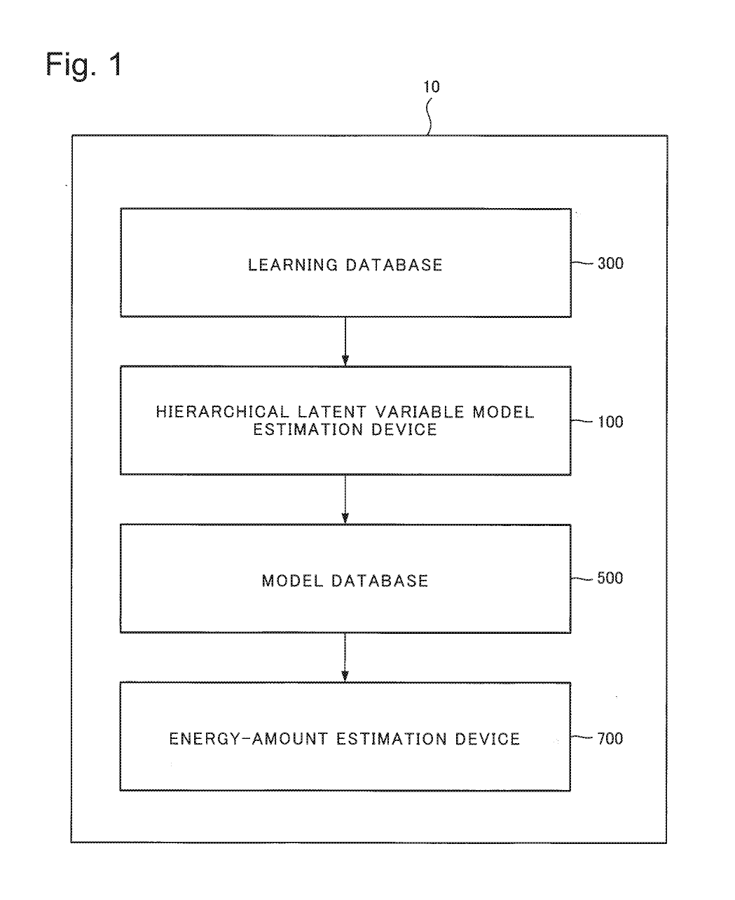

FIG. 1 is a block diagram illustrating an exemplary configuration of an energy-amount estimation system according to at least one exemplary embodiment of the present invention.

An energy-amount prediction system 10 according to this exemplary embodiment includes an estimation device 100 of a hierarchical latent variable model (a hierarchical latent variable model estimation device 100), a learning database 300, a model database 500, and an energy-amount prediction device 700. The energy-amount prediction system 10 generates a model for predicting the energy amount based on information concerning the energy amount to predict the energy amount using the model.

The hierarchical latent variable model estimation device 100 estimates a model for estimating (predicting) the energy amount using data stored in the learning database 300 and stores the model in the model database 500.

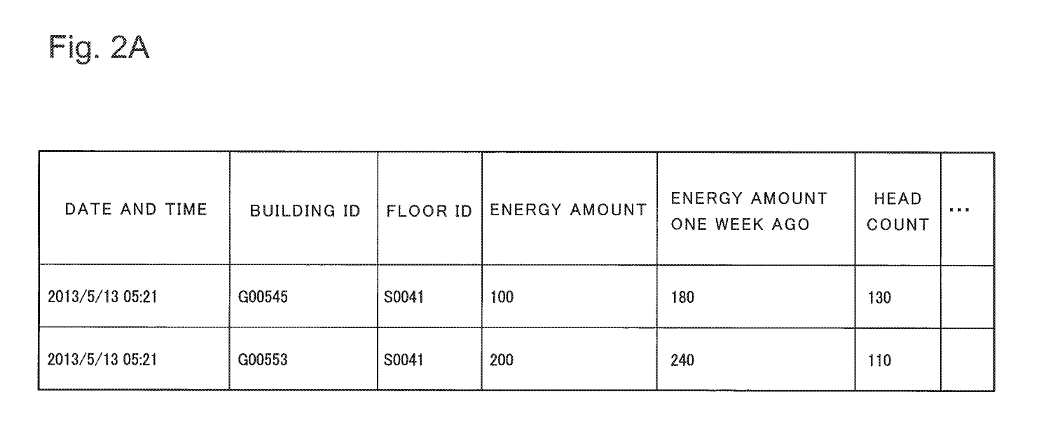

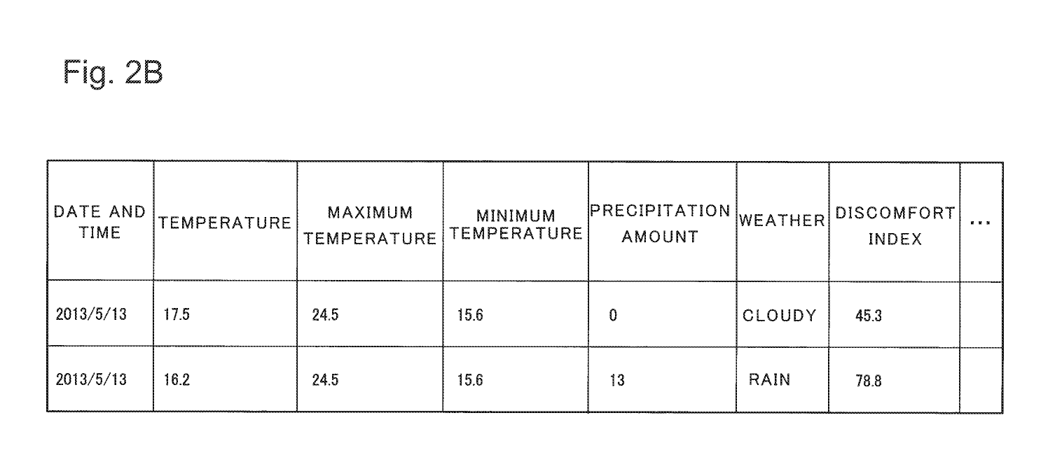

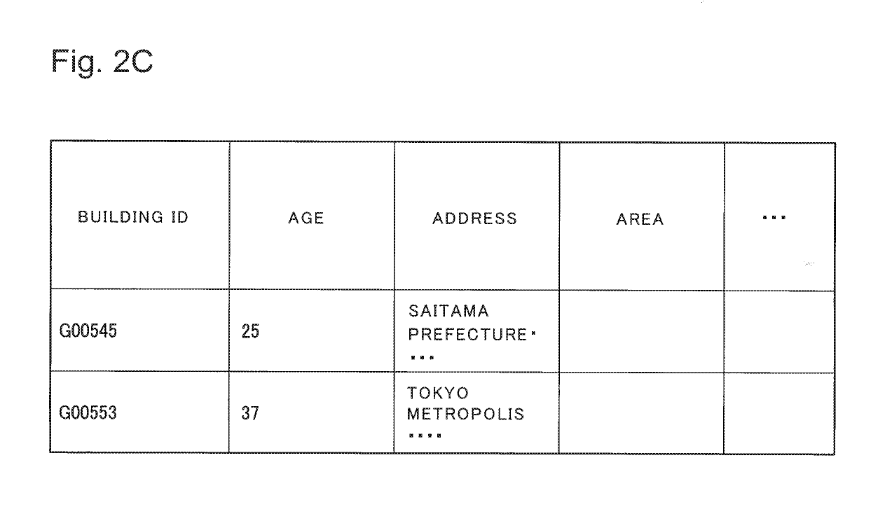

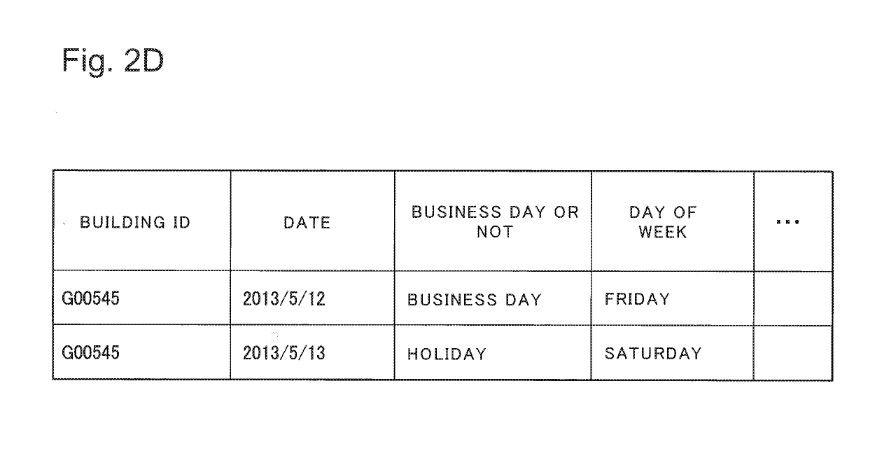

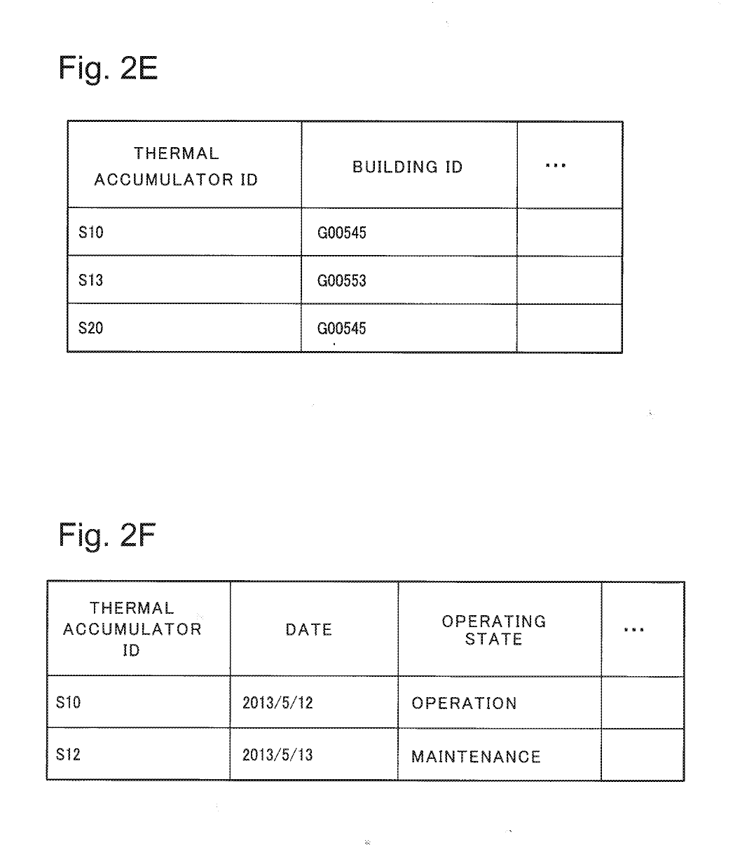

FIG. 2A to FIG. 2F is a table illustrating an example of information stored in a learning database according to at least one exemplary embodiment of the present invention.

Data related to a calendar indicating a weekday or a holiday, a day of the week, and the like is stored in the learning database 300.

Energy amount information relating an energy amount to a factor potentially influencing the energy amount is stored in the learning database 300. As exemplified in FIG. 2A, an energy amount table includes a date and time associated with a building identifier (ID), an energy amount, a head count, and the like.

Further, a meteorological table including data related to a meteorological phenomenon is stored in the learning database 300. As illustrate in FIG. 2B, the meteorological table includes a date associated with a temperature, the maximum temperature of the day, the minimum temperature of the day, a precipitation amount, weather, an discomfort index, and the like.

Further, a building table including data related to a building-or-the-like is stored in the learning database 300. As illustrated in FIG. 2C, the building table includes a building ID associated with an age, an address, an area, and the like.

Further, a building calendar table including data related to a business day is stored in the learning database 300. As illustrated in FIG. 2D, the building calendar table includes a building ID associated with a date, information indicating whether a day is a business day or not, and the like.

Further, a thermal storage system table including data related to a thermal storage system is stored in the learning database 300. As illustrated in FIG. 2E, the thermal storage system table includes a thermal accumulator ID associated with a building ID and the like.

Further, a thermal-storage-system calendar table including an operating state related to a thermal storage system is stored in the learning database 300. As illustrated in FIG. 2F, the thermal-storage-system calendar table includes a thermal accumulator ID associated with a date, an operating state, and the like.

The model database 500 stores a model for predicting the energy amount estimated by the hierarchical latent variable model estimation device 100. The model database 500 is implemented with a non-transitory tangible medium such as a hard disk drive or a solid-state drive.

The energy-amount prediction device 700 receives data associated with an energy amount related to a building and predicts the energy amount based on these data and the model stored in the model database 500.

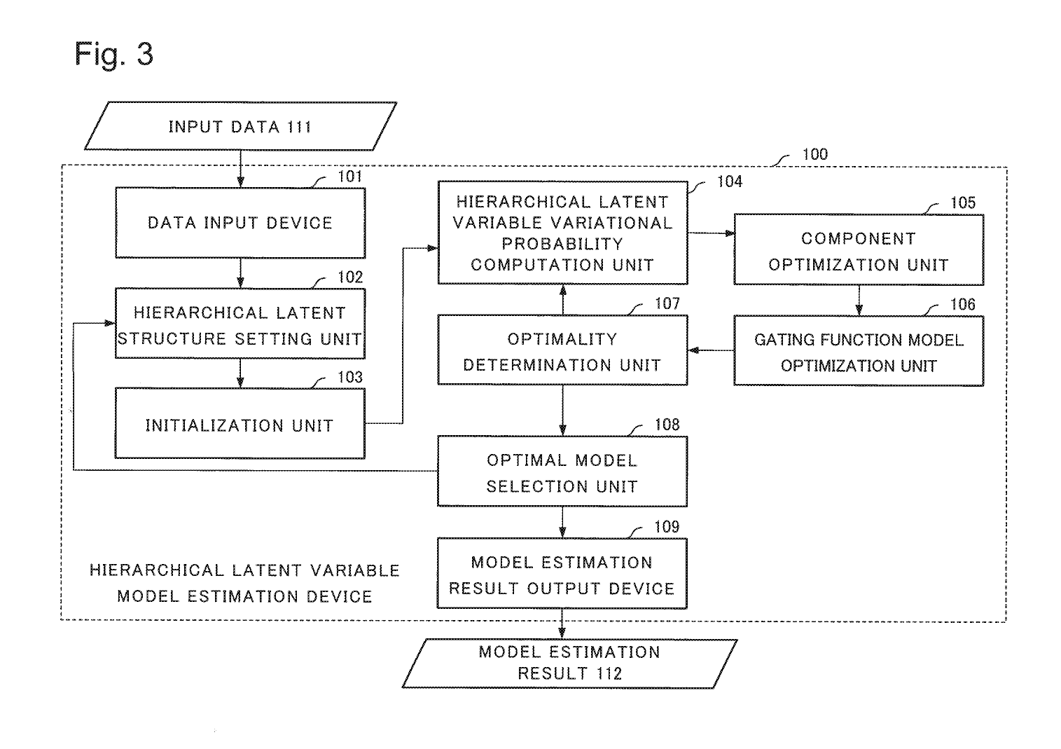

FIG. 3 is a block diagram illustrating an exemplary configuration of the hierarchical latent variable model estimation device according to at least one exemplary embodiment. The hierarchical latent variable model estimation device 100 according to this exemplary embodiment includes a data input device 101, a setting unit 102 of a hierarchical latent structure (a hierarchical latent structure setting unit 102), an initialization unit 103, a calculation processing unit 104 of a variational probability of a hierarchical latent variable (a hierarchical latent variable variational probability computation unit 104), and an optimization unit 105 of a component (a component optimization unit 105). The hierarchical latent variable model estimation device 100 further includes an optimization unit 106 of a gating function (a gating function model optimization unit 106), an optimality determination unit 107, an optimal model selection unit 108, and an output device 109 of a model estimation result (a model estimation result output device 109).

Upon receiving input data 111 generated based on the data stored in the learning database 300, the hierarchical latent variable model estimation device 100 optimizes the hierarchical latent structure and the type of observation probability for the input data 111. The hierarchical latent variable model estimation device 100 then outputs the optimization result as a model estimation result 112 and stores the model estimation result 112 into the model database 500. In this exemplary embodiment, the input data 111 exemplifies learning data.

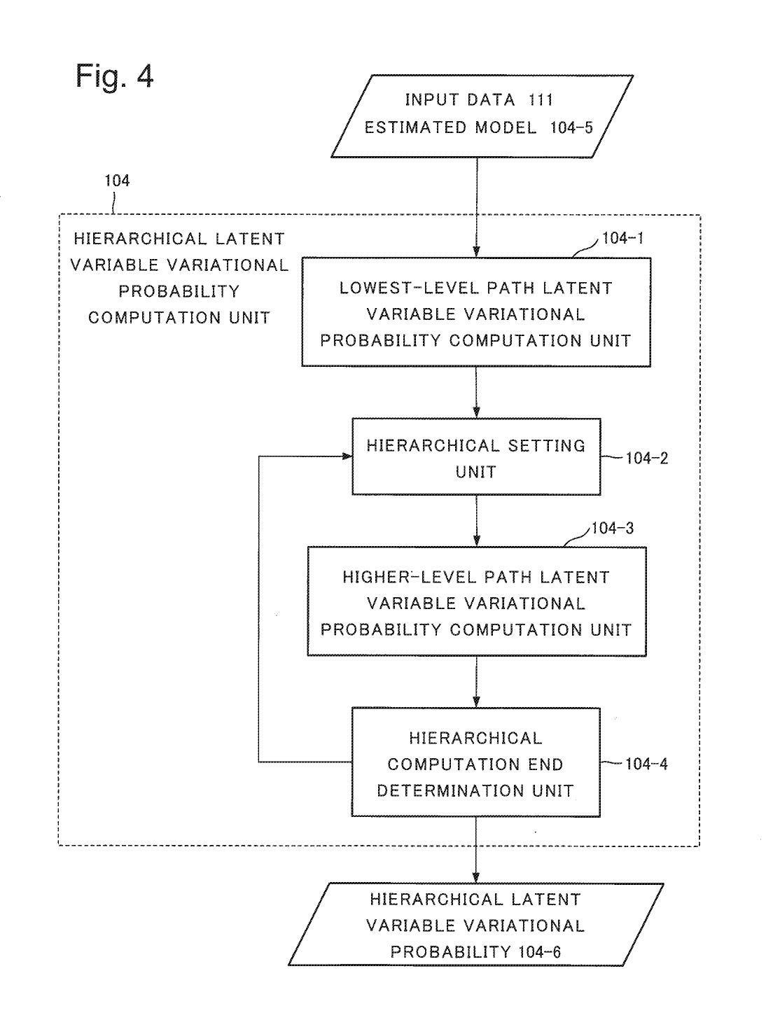

FIG. 4 is a block diagram illustrating an exemplary configuration of the hierarchical latent variable variational probability computation unit 104 according to at least one exemplary embodiment of the present invention. The hierarchical latent variable variational probability computation unit 104 includes a calculation processing unit 104-1 of a variational probability of a lowest-level path latent variable (a lowest-level path latent variable variational probability computation unit 104-1), a hierarchical setting unit 104-2, a calculation processing unit 104-3 of a variational probability of a higher-level path latent variable (a higher-level path latent variable variational probability computation unit 104-3), and a determination unit 104-4 of an end of a hierarchical calculation processing (a hierarchical computation end determination unit 104-4).

The hierarchical latent variable variational probability computation unit 104 outputs a hierarchical latent variable variational probability 104-6 in accordance with the input data 111, and an estimated model 104-5 in the component optimization unit 105 for a component (to be described later). The hierarchical latent variable variational probability computation unit 104 will be described in more detail later. The component in this exemplary embodiment is defined as a value indicating the weight (parameter) applied to each explanatory variable. The energy-amount prediction device 700 can obtain a target variable by computing the sum of explanatory variables each multiplied by the weight indicated by the component.

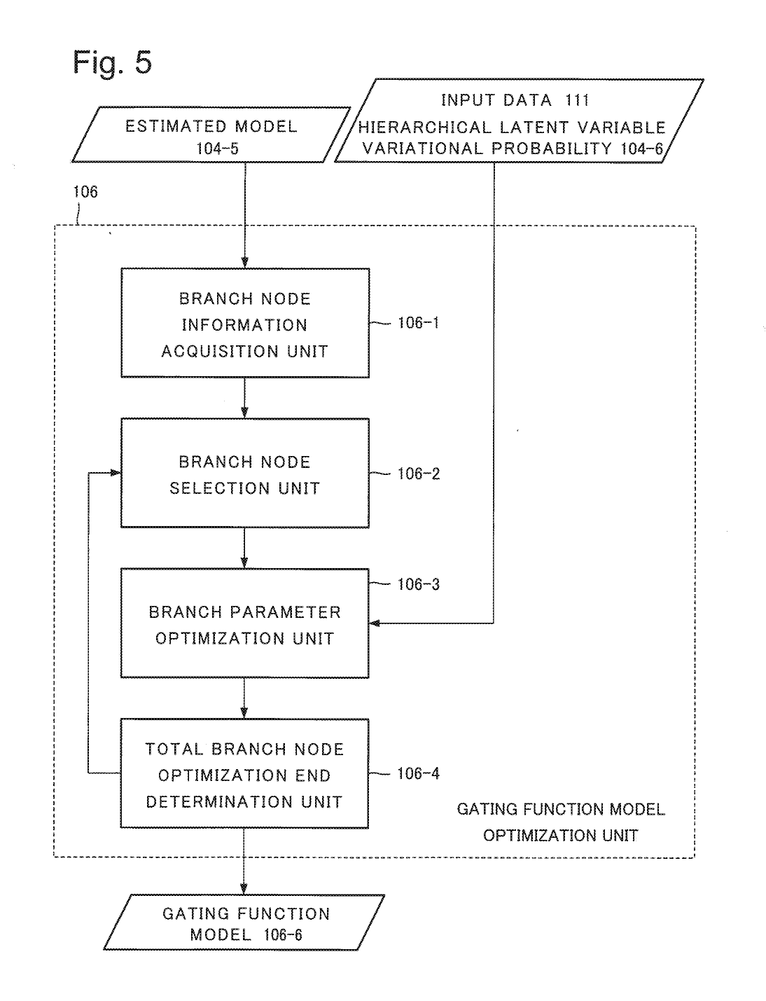

FIG. 5 is a block diagram illustrating an exemplary configuration of the gating function model optimization unit 106 according to at least one exemplary embodiment of the present invention. The gating function model optimization unit 106 includes an information acquisition unit 106-1 of a branch node (a branch node information acquisition unit 106-1), a selection unit 106-2 of a branch node (a branch node selection unit 106-2), an optimization unit 106-3 of a branch parameter (a branch parameter optimization unit 106-3), and a determination unit 106-4 of an end of optimization of a total branch node (a total branch node optimization end determination unit 106-4).

The gating function model optimization unit 106 receive the input data 111, a hierarchical latent variable variational probability 104-6, that is calculated by a hierarchical latent variable variational probability computation unit 104 (to be described later), and an estimated model 104-5, that is estimated by a component optimization unit 105 (to be described later). The gating function model optimization unit 106 outputs a gating function model 106-6 in accordance with the three inputs. The gating function model optimization unit 106 will be descried in more detail later. The gating function in this exemplary embodiment is used to determine whether the information in the input data 111 satisfies a predetermined condition. The gating function model is set at internal nodes of the hierarchical latent structure. The internal nodes indicates nodes except nodes at the lowest level. In tracing the path from the root node to the node at the lowest level, the energy-amount prediction device 700 determines a node to be traced next in accordance with the determination result based on the gating function model.

The data input device 101 is a device inputting the input data 111. The data input device 101 generates a target variable representing an energy amount consumed in a predetermined period (such as one hour and six hours) on the basis of data recorded in energy amount information stored in the learning database 300. The target variable may represent, for example, a total energy amount consumed in a building-or-the-like of interest in a predetermined period, an energy amount consumed on each floor in a building-or-the-like, an energy amount consumed by a device in a predetermined period. Further, an energy amount as a prediction target has only to be a measurable energy amount, and may be a generated energy amount.

Further, the data input device 101 generates explanatory variables on the basis of data recorded in the meteorological table, the energy amount table, the building table, the building calendar table, the thermal storage system table, the thermal-storage-system calendar table, and the like stored in the learning database 300. Specifically, for each target variable, the data input device 101 generates one or more explanatory variables being information potentially influencing the target variable. Then, the data input device 101 inputs a plurality of combinations of a target variable and explanatory variables as the input data 111. When inputting the input data 111, the data input device 101 also inputs parameters required for model estimation, such as an observation probability type and a candidate of a number of components. The data input device 101 according to the present exemplary embodiment is an example of a learning information input unit.

The hierarchical latent structure setting unit 102 selects the structure of a hierarchical latent variable model as a candidate for optimization based on the input types of observation probability and the input candidates for the number of components, and set the selected structure to a target for optimization. The latent structure used in this exemplary embodiment is a tree structure. Letting C be the set number of components. Let equations used for the following description be equations for a hierarchical latent variable model of depth 2. The hierarchical latent structure setting unit 102 may store the selected structure of a hierarchical latent variable model in a memory.

Assuming, for example, that a binary tree model (a model having a bifurcation at each branch node) is used and the depth of tree structure is 2, the hierarchical latent structure setting unit 102 selects a hierarchical latent structure having two nodes at the first level and four nodes at the second level (in this exemplary embodiment, the nodes at the lowest level).

The initialization unit 103 performs an initialization process for estimating a hierarchical latent variable model. The initialization unit 103 can perform the initialization process by an arbitrary method. The initialization unit 103 may, for example, randomly set the type of observation probability for each component and, in turn, randomly set a parameter for each observation probability in accordance with the set type. The initialization unit 103 may further randomly set a lowest-level path variational probability for the hierarchical latent variable.

The hierarchical latent variable variational probability computation unit 104 computes the path latent variable variational probability for each hierarchical level. The parameter θ is computed by the initialization unit 103 or the component optimization unit 105, the gating function model optimization unit 106 and so on. Therefore, the hierarchical latent variable variational probability computation unit 104 computes the variational probability on the basis of the obtained value.

The hierarchical latent variable variational probability computation unit 104 obtains a Laplace approximation of the marginal log-likelihood function with respect to an estimation (for example, a maximum likelihood estimate or a maximum a posteriori probability estimate) for the complete variable and maximizes its lower bound to compute the variational probability. The thus computed variational probability will be referred to as an optimization criterion A hereinafter.

The procedure of computing the optimization criterion A will be described by taking a hierarchical latent variable model of depth 2 as an example. The marginal log-likelihood function is given by:

$$log p ( {x}^{N} \vert M ) \geq {\sum }_{{Z}^{N}} q ( {z}^{N} ) log \{ \frac{p ( {x}^{N} , {z}^{N} \vert M )}{q ( {z}^{N} )} \} \qquad ( Eqn . 2 )$$

Where log represents, for example, a logarithm function. A base of the logarithm function is, for example, a Napier's value. The same applies to equations to be presented hereinafter.

The lower bound of the marginal log-likelihood function presented in Eqn. 2 will be considered first. In Eqn. 2, the equality holds true when the lowest-level path latent variable variational probability q(zⁿ) is maximized. Deriving a Laplace approximation of the marginal likelihood of the complete variable of the numerator in accordance with a maximum likelihood estimate for the complete variable yields an approximate expression of the marginal log-likelihood function given by:

$$J ( q , \overline{θ} , {x}^{N} ) = {\sum }_{{z}^{N}} q ( {z}^{N} ) \{ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} log ( {\sum }_{n = 1}^{N} {\sum }_{j = 1}^{{K}_{2}} {z}_{ij}^{n} ) - {\sum }_{i = 1}^{{K}_{1}} {\sum }_{j = 1}^{{K}_{2}} \frac{{D}_{{φ}_{ij}}}{2} log ( {\sum }_{n = 1}^{N} {z}_{ij}^{n} ) - log q ( {z}^{N} ) \} \qquad ( Eqn . 3 )$$

In Eqn. 3, the bar put over the letter symbolizes the maximum likelihood estimate for the complete variable, and Dₛ is the dimension of the subscript parameter *.

On the basis of the facts that the maximum likelihood estimate has the property of maximizing the marginal log-likelihood function and that the logarithmic function is expressed as a concave function, the lower bound presented in Eqn. 3 is calculated as Eqn. 4 represented as follows.

$$g ( q , {q}^{′} , {q}^{″} , θ , {x}^{N} ) = {\sum }_{{Z}^{N}} q ( {z}^{N} ) [ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} \{ log ( {\sum }_{n = 1}^{N} {q}^{′} ( {z}_{i}^{n} ) ) + \frac{{\sum }_{n = 1}^{N} {\sum }_{j = 1}^{{K}_{2}} {z}_{ij}^{n}}{{\sum }_{n = 1}^{N} {q}^{′} ( {z}_{i}^{n} )} - 1 \} - {\sum }_{i = 1}^{{K}_{1}} {\sum }_{j = 1}^{{K}_{2}} \frac{{D}_{{φ}_{ij}}}{2} \{ log ( {\sum }_{n = 1}^{N} {q}^{″} ( {z}_{ij}^{n} ) ) + \frac{{\sum }_{n = 1}^{N} {z}_{ij}^{n}}{{\sum }_{n = 1}^{N} {q}^{″} ( {z}_{ij}^{n} )} - 1 \} - log q ( {z}^{N} ) ] \qquad ( Eqn . 4 )$$

The variational distribution q′ of the first-level branch latent variable and the variational distribution q″ of the lowest-level path latent variable are calculated by maximizing Eqn. 4 for the respective variational distributions. Note that q″=q^{{t-1}} and θ=θ^{{t-1}} are fixed and q′ is fixed to a value given by Eqn. A.

$${q}^{′} = {\sum }_{j = 1}^{{K}_{2}} {q}^{\{ t - 1 \}} \qquad ( Eqn . A )$$

Note that the superscript (t) represents the t-th iteration in iterative computation of the hierarchical latent variable variational probability computation unit 104, the component optimization unit 105, the gating function model optimization unit 106, and the optimality determination unit 107.

An exemplary operation of the hierarchical latent variable variational probability computation unit 104 will be described below with reference to FIG. 4.

The lowest-level path latent variable variational probability computation unit 104-1 receives the input data 111 and the estimated model 104-5 and computes the lowest-level latent variable variational probability q(z^{N}). The hierarchical setting unit 104-2 sets the lowest level for which the variational probability is to be computed. More specifically, the lowest-level path latent variable variational probability computation unit 104-1 computes the variational probability of each estimated model 104-5 for each combination of a target variable and an explanatory variable in the input data 111. The value of the variational probability is computed by a comparison between a solution obtained by substituting the explanatory variable in the input data 111 into the estimated model 104-5 and the target variable of the input data 111.

The higher-level path latent variable variational probability computation unit 104-3 computes the path latent variable variational probability for immediately higher level. More specifically, the higher-level path latent variable variational probability computation unit 104-3 computes the sum of latent variable variational probabilities of the current level having a common branch node as a parent and sets the obtained sum as the path latent variable variational probability for immediately higher level.

The hierarchical computation end determination unit 104-4 determines whether any higher level for which the variational probability is to be computed remains. If it is determined that any higher level is present, the hierarchical setting unit 104-2 sets immediately higher level for which the variational probability is to be computed. Subsequently, the higher-level path latent variable variational probability computation unit 104-3 and the hierarchical computation end determination unit 104-4 repeat the above-mentioned processes. If it is determined that any higher level is absent, the hierarchical computation end determination unit 104-4 determines that path latent variable variational probabilities have been computed for all levels.

The component optimization unit 105 optimizes the model of each component (the parameter θ and its type S) for Eqn. 4 and outputs the optimized, estimated model 104-5. In the case of a hierarchical latent variable model of depth 2, the component optimization unit 105 fixes q and q″ to the variational probability q(t) of the lowest-level path latent variable computed by the hierarchical latent variable variational probability computation unit 104. The component optimization unit 105 further fixes q′ to the higher-level path latent variable variational probability presented in Eqn. A. The component optimization unit 105 then computes a model for maximizing the value of G presented in Eqn. 4.

Let S₁, . . . , S_{K1×K2} be the type of observation probability for φₖ. In the case of, for example, a multivariate data generation probability, examples of candidates for S₁ to S_{K1×K2} may include normal distribution, lognormal distribution, or exponential distribution. Alternatively, when, for example, a polynomial curve is output, examples of candidates for S₁ to S_{K1×K2} may include zeroth-order curve, linear curve, quadratic curve, or cubic curve.

G defined by Eqn. 4 allows decomposition of an optimization function for each component. It is, therefore, possible to independently optimize S₁ to S_{K1×K2} and the parameters φ₁ to φ_{K1×K2} with no concern for a combination of types of components (for example, designation of any of S₁ to S_{K1×K2}). In this process, importance is placed on enabling such optimization. This makes it possible to optimize the type of component while avoiding combinatorial explosion.

An exemplary operation of the gating function model optimization unit 106 will be described below with reference to FIG. 5. The branch node information acquisition unit 106-1 extracts a list of branch nodes using the estimated model 104-5 in the component optimization unit 105. The branch node selection unit 106-2 selects one branch node from the extracted list of branch nodes. The selected node will sometimes be referred to as a “selection node” hereinafter.

The branch parameter optimization unit 106-3 optimizes the branch parameter of the selection node on the basis of the input data 111 and the latent variable variational probability for the selection node obtained from the hierarchical latent variable variational probability 104-6. The branch parameter of the selection node is in the above-mentioned gating function model.

The total branch node optimization end determination unit 106-4 determines whether all branch nodes extracted by the branch node information acquisition unit 106-1 have been optimized. If all branch nodes have been optimized, the gating function model optimization unit 106 ends the process in this sequence. If all branch nodes have not been optimized, a process is performed by the branch node selection unit 106-2 and subsequent processes are performed by the branch parameter optimization unit 106-3 and the total branch node optimization end determination unit 106-4.

The gating function will be described hereinafter by taking, as a specific example, a gating function based on the Bernoulli distribution for a binary tree hierarchical model. A gating function based on the Bernoulli distribution will sometimes be referred to as a “Bernoulli gating function” hereinafter. Let x_{d} be the d-th dimension of x, g− be the probability of a branch of the binary tree to the lower left when this value is equal to or smaller than a threshold w, and g+ be the probability of a branch of the binary tree to the lower left when this value is larger than the threshold w. The branch parameter optimization unit 106-3 optimizes the above-mentioned optimization parameters d, w, g−, and g+ based on the Bernoulli distribution. This enables more rapid optimization because each parameter has an analytic solution, differently from the gating function based on the logit function described in NPL 1.

The optimality determination unit 107 determines whether the optimization criterion A computed using Eqn. 4 has converged. If the optimization criterion A has not converged, the processes by the hierarchical latent variable variational probability computation unit 104, the component optimization unit 105, the gating function model optimization unit 106, and the optimality determination unit 107 are repeated. The optimality determination unit 107 may determine that the optimization criterion A has converged when, for example, the increment of the optimization criterion A is smaller than a predetermined threshold.

The processes by the hierarchical latent variable variational probability computation unit 104, the component optimization unit 105, the gating function model optimization unit 106, and the optimality determination unit 107 will sometimes simply be referred to hereinafter as a first processes. An appropriate model can be selected by repeating the first process and updating the variational distribution and the model. Repeating these processes ensures monotone increasing of the optimization criterion A.

The optimal model selection unit 108 selects an optimal model. Assume, for example, that the optimization criterion A computed in the first process is larger than the currently set optimization criterion A, for the number of hidden states set by the hierarchical latent structure setting unit 102. Then, the optimal model selection unit 108 selects the model as an optimal model.

The model estimation result output device 109 optimizes the model with regard to candidates for the structure of a hierarchical latent variable model set from the input type of observation probability and the input candidates for the number of components. If the optimization is complete, the model estimation result output device 109 outputs, for example, the number of optimal hidden states, the type of observation probability, the parameter, and the variational distribution as a model estimation result 112. If any candidate remains to be optimized, the hierarchical latent structure setting unit 102 similarly performs the above-mentioned processes.

The central processing unit (to be abbreviated as the “CPU” hereinafter) of a computer operating in accordance with a program (hierarchical latent variable model estimation program) implements the following respective units:
the hierarchical latent structure setting unit 102;
the initialization unit 103;
the hierarchical latent variable variational probability computation unit 104 (more specifically, the lowest-level path latent variable variational probability computation unit 104-1, the hierarchical setting unit 104-2, the higher-level path latent variable variational probability computation unit 104-3, and the hierarchical computation end determination unit 104-4);
the component optimization unit 105;
the gating function model optimization unit 106 (more specifically, the branch node information acquisition unit 106-1, the branch node selection unit 106-2, the branch parameter optimization unit 106-3, and the total branch node optimization end determination unit 106-4);
the optimality determination unit 107; and
the optimal model selection unit 108.

For example, the program is stored in a storage unit (not illustrated) of the hierarchical latent variable model estimation device 100, and the CPU reads this program and executes the processes in accordance with this program, in the following respective units:
the hierarchical latent structure setting unit 102;
the initialization unit 103;
the hierarchical latent variable variational probability computation unit 104 (more specifically, the lowest-level path latent variable variational probability computation unit 104-1, the hierarchical setting unit 104-2, the higher-level path latent variable variational probability computation unit 104-3, and the hierarchical computation end determination unit 104-4);
the component optimization unit 105;
the gating function model optimization unit 106 (more specifically, the branch node information acquisition unit 106-1, the branch node selection unit 106-2, the branch parameter optimization unit 106-3, and the total branch node optimization end determination unit 106-4);
the optimality determination unit 107; and
the optimal model selection unit 108.

Dedicated hardware may be used to implement the following respective units:
the hierarchical latent structure setting unit 102;
the initialization unit 103;
the hierarchical latent variable variational probability computation unit 104;
the component optimization unit 105;
the gating function model optimization unit 106;
the optimality determination unit 107; and
the optimal model selection unit 108.

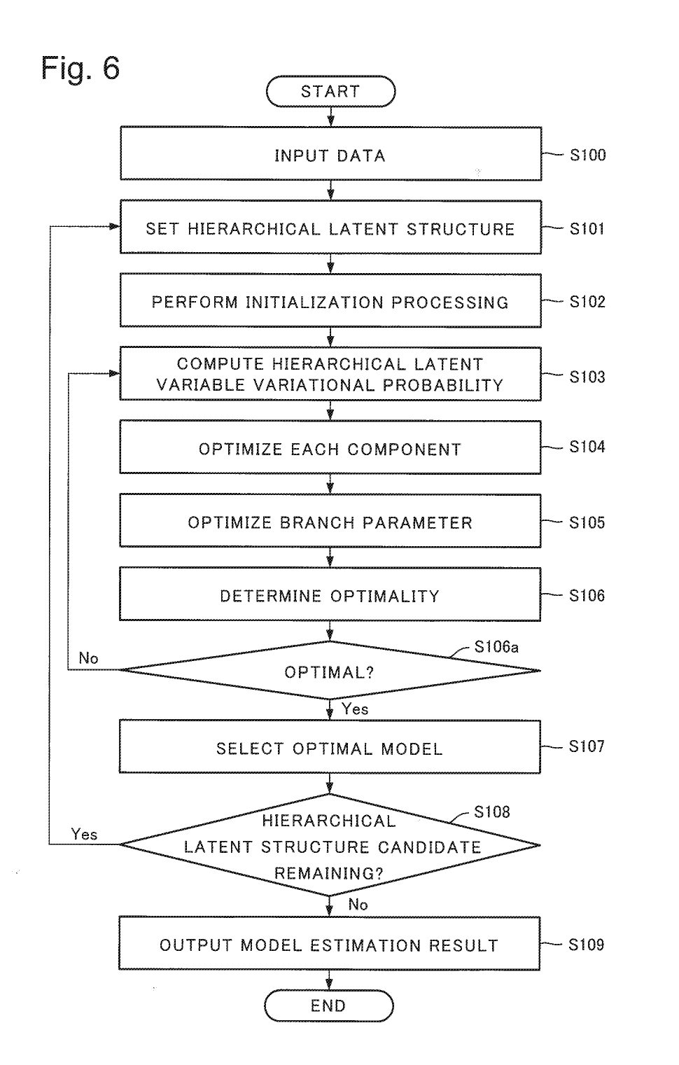

An exemplary operation of the hierarchical latent variable model estimation device according to this exemplary embodiment will be described below. FIG. 6 is a flowchart illustrating an exemplary operation of the hierarchical latent variable model estimation device according to at least one exemplary embodiment of the present invention.

The data input device 101 receives input data 111 first (step S100). The hierarchical latent structure setting unit 102 then selects a hierarchical latent structure remaining and set the selected structure to be optimized in the input candidate values of the hierarchical latent structure (step S101). The initialization unit 103 initializes the latent variable variational probability and the parameters used for estimation, for the set hierarchical latent structure (step S102).

The hierarchical latent variable variational probability computation unit 104 computes each path latent variable variational probability (step S103). The component optimization unit 105 optimize each component by estimating the type of observation probability and the parameters (step S104).

The gating function model optimization unit 106 optimizes the branch parameter of each branch node (step S105). The optimality determination unit 107 determines whether the optimization criterion A has converged or not (step S106). In other words, the optimality determination unit 107 determines the model optimality.

If it is determined in step S106 that the optimization criterion A has not converged (that is, determined that the model is not optimal) (NO in step S106a), the processes in steps S103 to S106 are repeated.

If it is determined in step S106 that the optimization criterion A has converted (that is, determined that the model is optimal) (YES in step S106a), the optimal model selection unit 108 performs the following process. In other words, the optimal model selection unit 108 compares the optimization criterion A obtained based on the currently set optimal model (for example, the number of components, the type of observation probability, and the parameters) and the value of the optimization criterion A obtained based on the model currently set as an optimal model. The optimal model selection unit 108 selects a model having a larger value as an optimal model (step S107).

The optimal model selection unit 108 determines whether any candidate for the hierarchical latent structure remains to be estimated or not (step S108). If any candidate remains (Yes in step S108), the processes in steps S101 to S108 are repeated. If no candidate remains (No in step S108), the model estimation result output device 109 outputs a model estimation result and ends the process (step S109). The model estimation result output device 109 stores the component optimized by the component optimization unit 105 and the gating function model optimized by the gating function model optimization unit 106 into the model database 500.

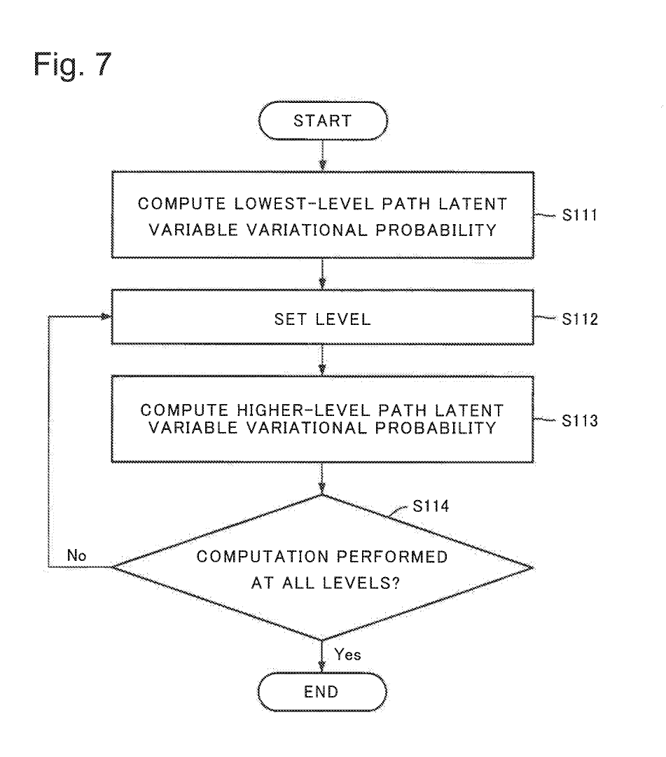

An exemplary operation of the hierarchical latent variable variational probability computation unit 104 according to this exemplary embodiment will be described below. FIG. 7 is a flowchart illustrating an exemplary operation of the hierarchical latent variable variational probability computation unit 104 according to at least one exemplary embodiment of the present invention.

The lowest-level path latent variable variational probability computation unit 104-1 computes the lowest-level path latent variable variational probability (step S111). The hierarchical setting unit 104-2 sets the latest level for which the path latent variable has been computed (step S112). The higher-level path latent variable variational probability computation unit 104-3 computes the path latent variable variational probability for immediately higher level on the basis of the path latent variable variational probability for the level set by the hierarchical setting unit 104-2 (step S113).

The hierarchical computation end determination unit 104-4 determines whether path latent variables have been computed for all levels (step S114). If any level for which the path latent variable is to be computed remains (No in step S114), the processes in steps S112 and S113 are repeated. If path latent variables have been computed for all levels (Yes in step S114), the hierarchical latent variable variational probability computation unit 104 ends the process.

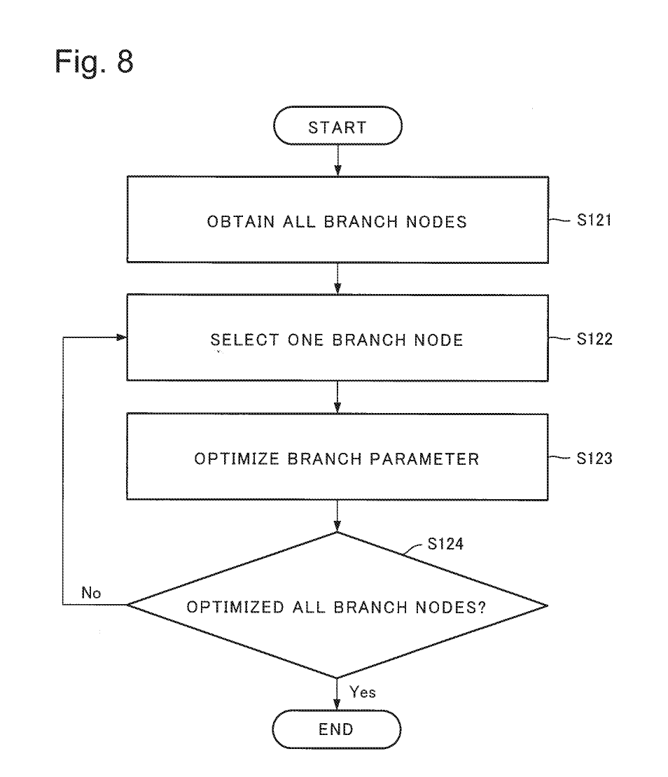

An exemplary operation of the gating function model optimization unit 106 according to this exemplary embodiment will be described below. FIG. 8 is a flowchart illustrating an exemplary operation of the gating function model optimization unit 106 according to at least one exemplary embodiment of the present invention.

The branch node information acquisition unit 106-1 determines all branch nodes (step S121). The branch node selection unit 106-2 selects one branch node to be optimized (step S122). The branch parameter optimization unit 106-3 optimizes the branch parameters of the selected branch node (step S123).

The total branch node optimization end determination unit 106-4 determines whether any branch node remains to be optimized (step S124). If any branch node remains to be optimized (No in step S124), the processes in steps S122 and S123 are repeated. If no branch node remains to be optimized (Yes in step S124), the gating function model optimization unit 106 ends the process.

As described above, according to this exemplary embodiment, the hierarchical latent structure setting unit 102 sets a hierarchical latent structure. In the hierarchical latent structure, latent variables are represented by a hierarchical structure (tree structure) and components representing probability models are assigned to the nodes at the lowest level of the hierarchical structure. The hierarchical structure has a structure where one or more nodes are set at each hierarchy and the structure that includes a course between nodes in the first hierarchy and nodes in immediately lower second hierarchy.

The hierarchical latent variable variational probability computation unit 104 computes the path latent variable variational probability (that is, the optimization criterion A). The hierarchical latent variable variational probability computation unit 104 may compute the latent variable variational probabilities in turn from the nodes at the lowest level, for each level of the hierarchical structure. Further, the hierarchical latent variable variational probability computation unit 104 may compute the variational probability so as to maximize the marginal log-likelihood.

The component optimization unit 105 optimizes the components for the computed variational probability. The gating function model optimization unit 106 optimizes the gating functions on the basis of the latent variable variational probability at each node of the hierarchical latent structure. The gating function model serves as a model for determining a branch direction in accordance with the multivariate data at the node of the hierarchical latent structure.

Since a hierarchical latent variable model for multivariate data is estimated using the above-mentioned configuration, a hierarchical latent variable model including hierarchical latent variables can be estimated with an adequate amount of computation without losing theoretical justification. Further, the use of the hierarchical latent variable model estimation device 100 obviates the need to manually set a criterion appropriate to select components.

The hierarchical latent structure setting unit 102 sets a hierarchical latent structure having latent variables represented in, for example, a binary tree structure. The gating function model optimization unit 106 may optimize the gating function model based on the Bernoulli distribution, on the basis of the latent variable variational probability at the node. This enables more rapid optimization because each parameter has an analytic solution.

With these processes, the hierarchical latent variable model estimation device 100 can generate components, such as an energy amount model defined by a parameter of temperature, a model defined according to a time zone, and an model defined a according to operational dates, on the basis of the values of the explanatory variables.

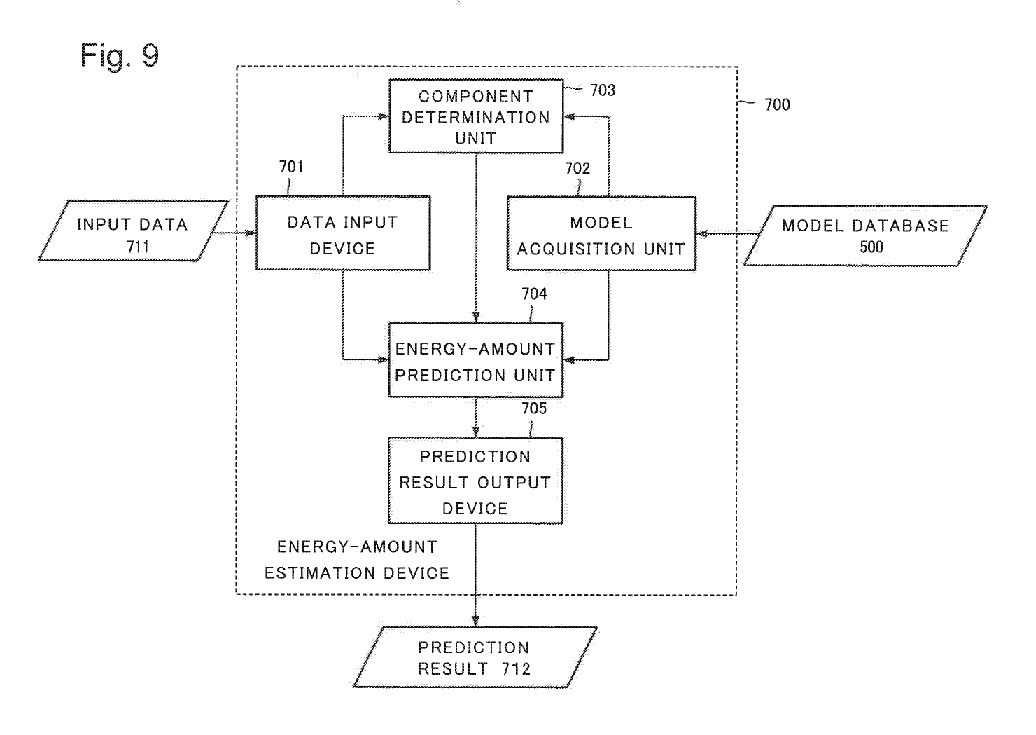

The energy-amount prediction device according to this exemplary embodiment will be described below. FIG. 9 is a block diagram illustrating an exemplary configuration of the energy-amount prediction device according to at least one exemplary embodiment of the present invention.

The energy-amount prediction device 700 includes a data input device 701, a model acquisition unit 702, a component determination unit 703, an energy-amount prediction unit 704, and an output device 705 of a result of prediction.

The data input device 701 receives, as input data 711, at least one explanatory variable that is information expected to influence the energy amount. The input data 711 is formed by the same types of explanatory variables as those forming the input data 111. In this exemplary embodiment, the data input device 701 exemplifies a prediction data input unit.

The model acquisition unit 702 reads a gating function model and a component from the model database 500 as a prediction model for the energy amount. The gating function model is optimized by the gating function model optimization unit 106. The component is optimized by the component optimization unit 105.

The component determination unit 703 traces the hierarchical latent structure on the basis of the input data 711 input to the data input device 701 and the gating function model read by the model acquisition unit 702. The component determination unit 703 selects a component associated with the node at the lowest level of the hierarchical latent structure as a component for predicting the energy amount.

The energy-amount prediction unit 704 predicts the energy amount by substituting the input data 711 input to the data input device 701 into the component selected by the component determination unit 703. The prediction result output device 705 outputs a prediction result 712 for the energy amount estimated by the energy-amount prediction unit 704.

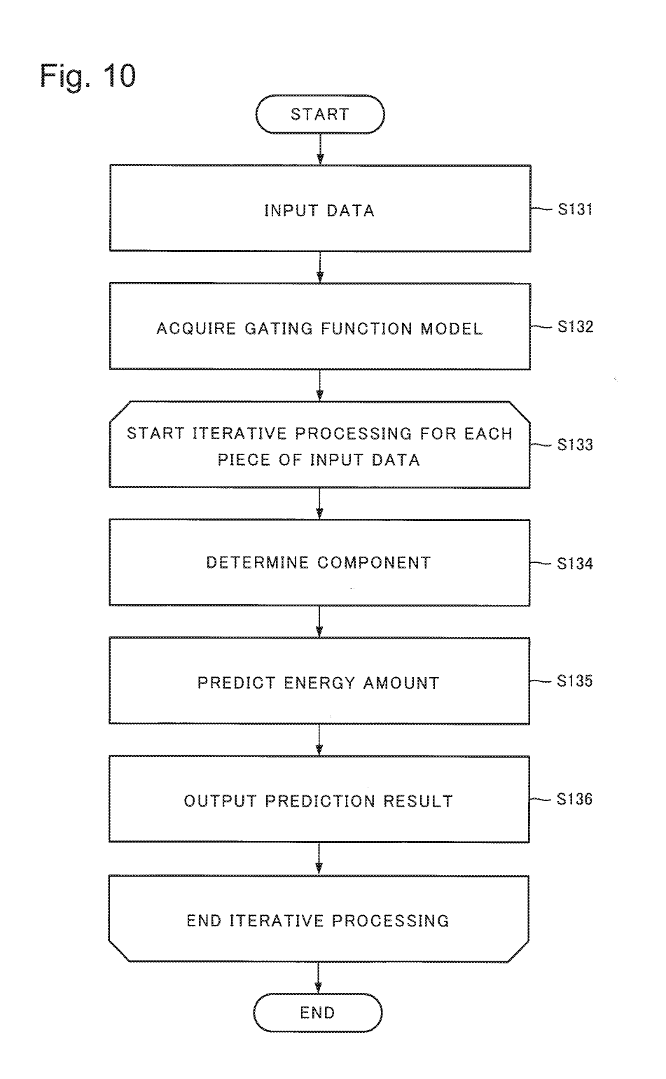

An exemplary operation of the energy-amount prediction device 700 according to this exemplary embodiment will be described below. FIG. 10 is a flowchart illustrating an exemplary operation of the energy-amount prediction device 700 according to at least one exemplary embodiment of the present invention.

The data input device 701 receives input data 711 first (step S131). The data input device 701 may receive a plurality of input data 711 instead of only one input data 711 (in each exemplary embodiment of the present invention, input data is a dataset of data (a set of information)). For example, the data input device 701 may receive input data 711 for each time of day (timing) on a certain date about a building. When the data input device 701 receives a plurality of input data 711, the energy-amount prediction unit 704 predicts the energy amount for each input data 711. The model acquisition unit 702 acquires a gating function and a component from the model database 500 (step S132).

The energy-amount prediction device 700 selects the input data 711 one by one and performs the following processes in steps S134 to S136 for the selected input data 711 (step S133).

The component determination unit 703 selects a component for predicting the energy amount by tracing the path from the root node to the node at the lowest level in the hierarchical latent structure in accordance with the gating function model acquired by the model acquisition unit 702 (step S134). More specifically, the component determination unit 703 selects a component in accordance with the following procedure.

The component determination unit 703 reads, for each node of the hierarchical latent structure, a gating function model associated with this node. The component determination unit 703 determines whether the input data 711 satisfies the read gating function model. The component determination unit 703 determines the node to be traced next in accordance with the determination result. Upon reaching the node at the lowest level through the nodes of the hierarchical latent structure by this process, the component determination unit 703 selects a component associated with this node as a component for prediction of the energy amount.

When the component determination unit 703 selects a component for predicting the energy amount in step S134, the energy-amount prediction unit 704 predicts the energy amount by substituting the input data 711 selected in step S133 into the component (step S135). The prediction result output device 705 outputs a prediction result 712 for the energy amount obtained by the energy-amount prediction unit 704 (step S136).

The energy-amount prediction device 700 performs the processes in steps S134 to S136 for all input data 711 and ends the process.

As described above, according to this exemplary embodiment, the energy-amount prediction device 700 can accurately estimate the energy amount using an appropriate component on the basis of the gating function. In particular, since the gating function and the component are estimated by the hierarchical latent variable model estimation device 100 without losing theoretical justification, the energy-amount prediction device 700 can predict the energy amount using components selected in accordance with an appropriate criterion.

### Second Exemplary Embodiment

A second exemplary embodiment of an energy-amount prediction system will be described next. The energy-amount prediction system according to this exemplary embodiment is different from the energy-amount prediction system 10 in that in the former, the hierarchical latent variable model estimation device 100 is replaced with an estimation device 200 of a hierarchical latent variable model (a hierarchical latent variable model estimation device 200).

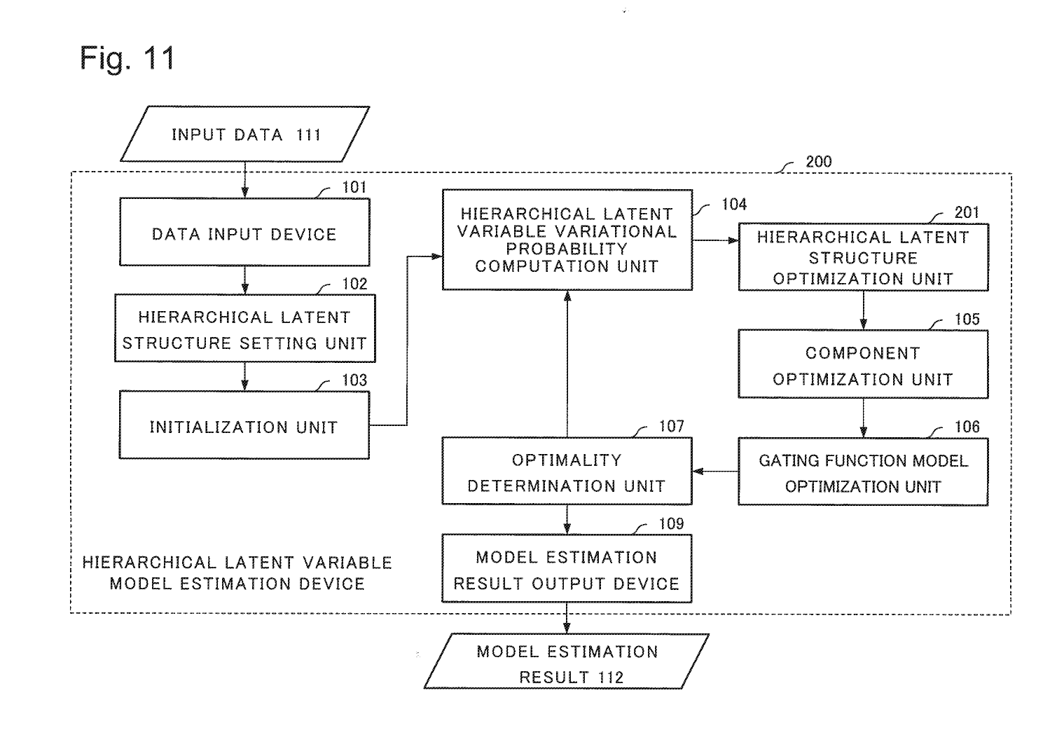

FIG. 11 is a block diagram illustrating an exemplary configuration of a hierarchical latent variable model estimation device according to at least one exemplary embodiment. The same reference numerals as in FIG. 3 denote the same configurations as in the first exemplary embodiment, and a description thereof will not be given. The hierarchical latent variable model estimation device 200 according to this exemplary embodiment is different from the hierarchical latent variable model estimation device 100 in that an optimization unit 201 of a hierarchical latent structure (a hierarchical latent structure optimization unit 201) is connected to the former while the optimal model selection unit 108 is not connected to the former.

In the first exemplary embodiment, the hierarchical latent variable model estimation device 100 optimizes the model of the component and the gating function model with regard to candidates for the hierarchical latent structure to select a hierarchical latent structure which maximizes the optimization criterion A. On the other hand, with the hierarchical latent variable model estimation device 200 according to this exemplary embodiment, a process for removing, by the hierarchical latent structure optimization unit 201, a path having its latent variable reduced from the model is added to the subsequent stage of the process by a hierarchical latent variable variational probability computation unit 104.

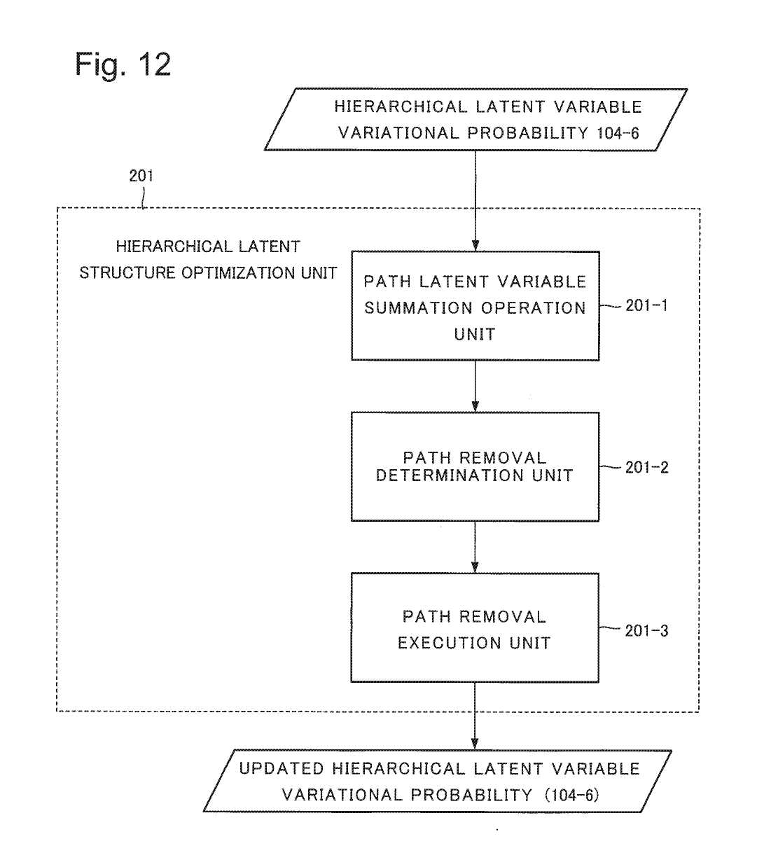

FIG. 12 is a block diagram illustrating an exemplary configuration of the hierarchical latent structure optimization unit 201 according to at least one exemplary embodiment. The hierarchical latent structure optimization unit 201 includes a summation operation unit 201-1 of a path latent variable (a path latent variable summation operation unit 201-1), a determination unit 201-2 of path removal (a path removal determination unit 201-2), and a removal execution unit 201-3 of a path (a path removal execution unit 201-3).

The path latent variable summation operation unit 201-1 receives a hierarchical latent variable variational probability 104-6 and computes the sum (to be referred to as the “sample sum” hereinafter) of lowest-level path latent variable variational probabilities in each component.

The path removal determination unit 201-2 determines whether the sample sum is equal to or smaller than a predetermined threshold c. The threshold c is input together with input data 111. More specifically, a condition determined by the path removal determination unit 201-2 can be expressed as, for example:

$${\sum }_{n = 1}^{N} q ( {z}_{ij}^{n} ) \leq ɛ \qquad ( Eqn . 5 )$$

More specifically, the path removal determination unit 201-2 determines whether the lowest-level path latent variable variational probability q(zᵢⱼⁿ) in each component satisfies the criterion presented in Eqn. 5. In other words, the path removal determination unit 201-2 determines whether the sample sum is sufficiently small.

The path removal execution unit 201-3 sets the variational probability of a path determined to have a sufficiently small sample sum to zero. The path removal execution unit 201-3 recomputes and outputs a hierarchical latent variable variational probability 104-6 at each hierarchical level on the basis of the lowest-level path latent variable variational probability normalized for the remaining paths (that is, paths whose variational probability is not set to be 0).

The justification of this process will be described below. An exemplary updated equation of q(zᵢⱼⁿ) in iterative optimization is given by:

$${q}^{t} ( {z}_{ij}^{n} ) ∝ {g}_{i}^{n} {g}_{j \vert i}^{n} p ( {x}^{n} \vert {φ}_{ij} ) exp \{ \frac{- {D}_{{β}_{i}}}{2 {\sum }_{n = 1}^{N} {\sum }_{j = 1}^{{K}_{2}} {q}^{t - 1} ( {z}_{ij}^{n} )} + \frac{- {D}_{{φ}_{ij}}}{2 {\sum }_{n = 1}^{N} {q}^{t - 1} ( {z}_{ij}^{n} )} \} \qquad ( Eqn . 6 )$$

In Eqn. 6, the exponential part includes a negative term and q(zᵢⱼⁿ) computed in the preceding process serves as the denominator of the term. Therefore, the smaller the value of this denominator, the smaller the value of optimized q(zᵢⱼⁿ), so that the variational probabilities of small path latent variables gradually reduce upon iterative computation.

The hierarchical latent structure optimization unit 201 (more specifically, the path latent variable summation operation unit 201-1, the path removal determination unit 201-2, and the path removal execution unit 201-3) is implemented by using the CPU of a computer operating in accordance with a program (hierarchical latent variable model estimation program).

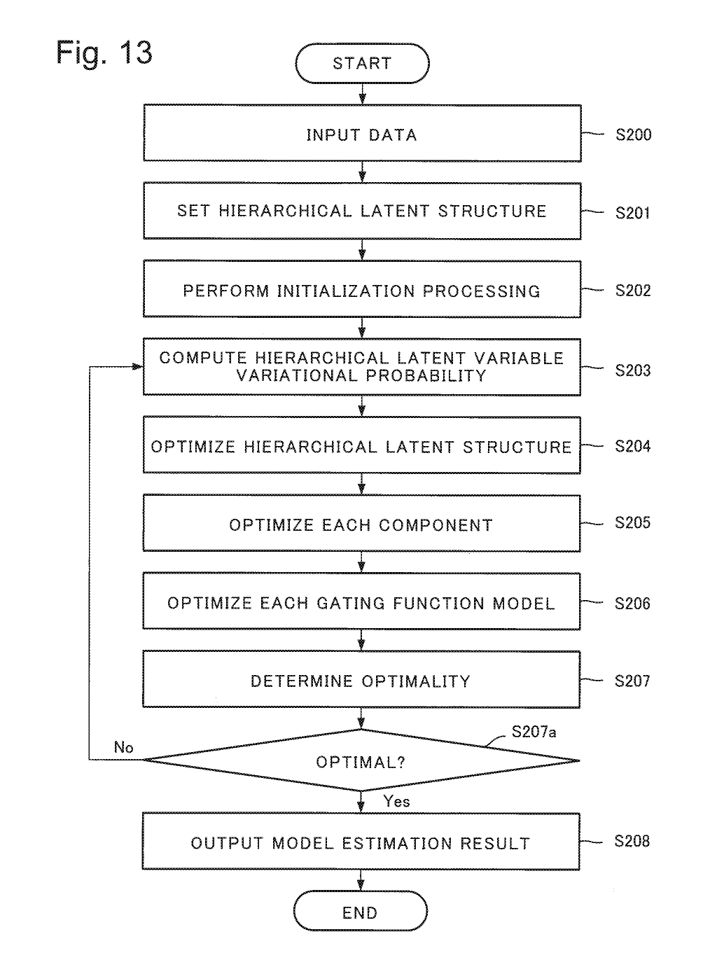

An exemplary operation of the hierarchical latent variable model estimation device 200 according to this exemplary embodiment will be described below. FIG. 13 is a flowchart illustrating an exemplary operation of the hierarchical latent variable model estimation device 200 according to at least one exemplary embodiment of the present invention.

A data input device 101 receives input data 111 first (step S200). A hierarchical latent structure setting unit 102 sets the initial state of the number of hidden states as a hierarchical latent structure (step S201).

In the first exemplary embodiment, an optimal solution is searched by executing all of a plurality of candidates for the number of components. In the second exemplary embodiment, the hierarchical latent structure can be optimized by only one process because the number of components is also optimized. Thus, in step S201, the initial value of the number of hidden states need only be set once instead of selecting a candidate remaining to be optimized from a plurality of candidates, as in step S102 of the first exemplary embodiment.

An initialization unit 103 initializes the latent variable variational probability and the parameter used for estimation, for the set hierarchical latent structure (step S202).

The hierarchical latent variable variational probability computation unit 104 computes each path latent variable variational probability (step S203). The hierarchical latent structure optimization unit 201 estimates the number of components to optimize the hierarchical latent structure (step S204). In other words, because the components are assigned to the respective nodes at the lowest level, when the hierarchical latent structure is optimized, the number of components is also optimized.

A component optimization unit 105 estimates the type of observation probability and the parameter for each component to optimize the components (step S205). A gating function model optimization unit 106 optimizes the branch parameter of each branch node (step S206). An optimality determination unit 107 determines whether the optimization criterion A has converged (step S207). In other words, the optimality determination unit 107 determines the model optimality.

If it is determined in step S207 that the optimization criterion A has not converged, that is, the model is not optimal (NO in step S207a), the processes in steps S203 to S207 are repeated.

If it is determined in step S207 that the optimization criterion A has converted (that is, the model is optimal) (YES in step S207a), a model estimation result output device 109 outputs a model estimation result 112 and ends the process (step S208).

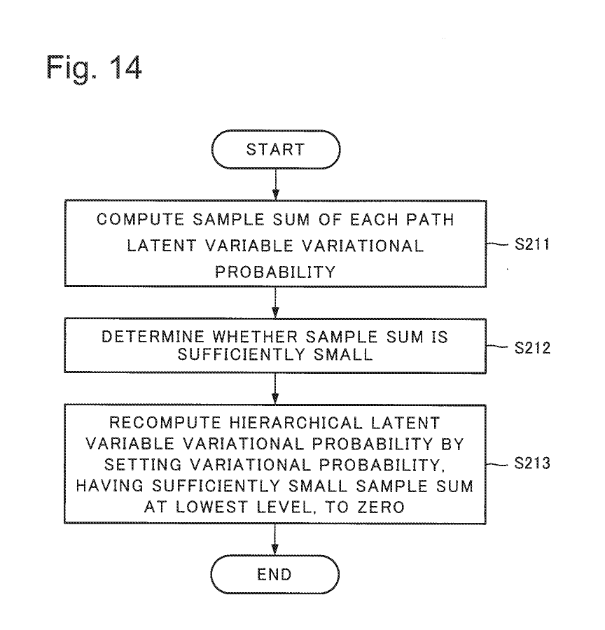

An exemplary operation of the hierarchical latent structure optimization unit 201 according to this exemplary embodiment will be described below. FIG. 14 is a flowchart illustrating an exemplary operation of the hierarchical latent structure optimization unit 201 according to at least one exemplary embodiment of the present invention.

The path latent variable summation operation unit 201-1 computes the sample sum of path latent variables first (step S211). The path removal determination unit 201-2 determines whether the computed sample sum is sufficiently small (step S212). The path removal execution unit 201-3 outputs a hierarchical latent variable variational probability recomputed after the lowest-level path latent variable variational probability determined to yield a sufficiently small sample sum is set to zero, and ends the process (step S213).

As descried above, in this exemplary embodiment, the hierarchical latent structure optimization unit 201 optimizes the hierarchical latent structure by removing a path having a computed variational probability equal to or lower than a predetermined threshold from the model.

With such a configuration, in addition to the effects of the first exemplary embodiment, a plurality of candidates for the hierarchical latent structure need not be optimized, as in the hierarchical latent variable model estimation device 100, and the number of components can be optimized as well by only one execution process. Therefore, the computation costs can be kept low by estimating the number of components, the type of observation probability, the parameters, and the variational distribution at once.

### Third Exemplary Embodiment

A third exemplary embodiment of an energy-amount prediction system will be described next. The energy-amount prediction system according to this exemplary embodiment is different from that according to the second exemplary embodiment in terms of the configuration of the hierarchical latent variable model estimation device. The hierarchical latent variable model estimation device according to this exemplary embodiment is different from the hierarchical latent variable model estimation device 200 in that in the former, the gating function model optimization unit 106 is replaced with an optimization unit 113 of a gating function model (a gating function model optimization unit 113).

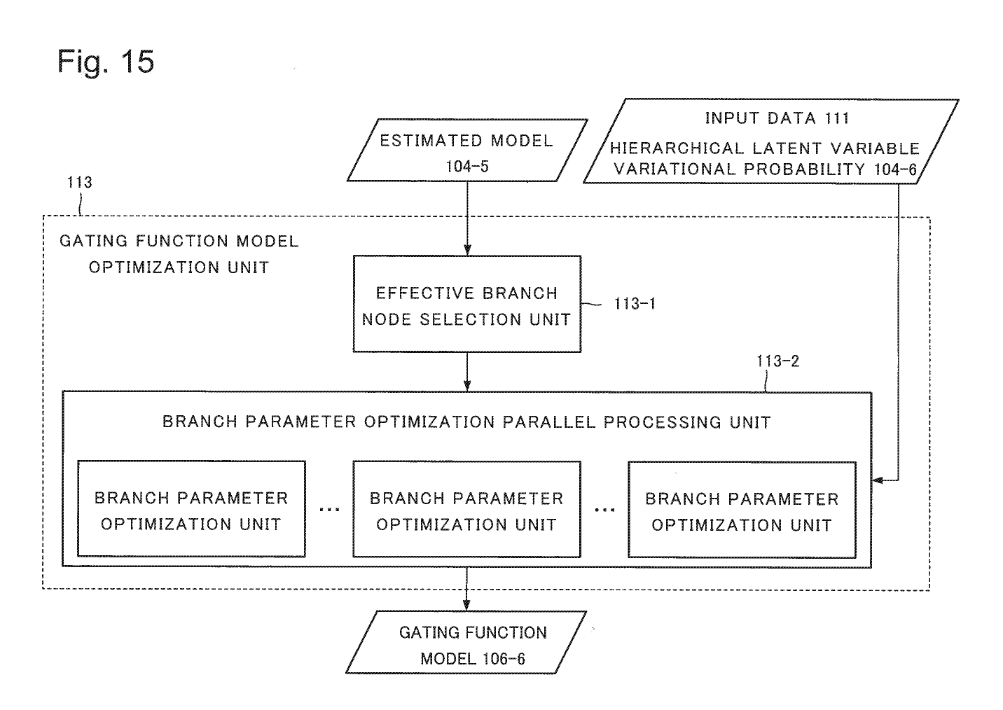

FIG. 15 is a block diagram illustrating an exemplary configuration of the gating function model optimization unit 113 according to the at least one exemplary embodiment of the present invention. The gating function model optimization unit 113 includes a selection unit 113-1 of an effective branch node (an effective branch node selection unit 113-1) and a parallel processing unit 113-2 of optimization of a branch parameter (a branch parameter optimization parallel processing unit 113-2).

The effective branch node selection unit 113-1 selects an effective branch node from the hierarchical latent structure. More specifically, the effective branch node selection unit 113-1 selects an effective branch node in consideration of paths removed from the model through the use of an model 104-5 estimated by a component optimization unit 105. The effective branch node indicates herein a branch node on a path not removed from the hierarchical latent structure.

The branch parameter optimization parallel processing unit 113-2 performs processes for optimizing the branch parameters for effective branch nodes in parallel and outputs the result of the processes as a gating function model 106-6. More specifically, the branch parameter optimization parallel processing unit 113-2 optimizes all branch parameters for all effective branch nodes, using input data 111 and a hierarchical latent variable variational probability 104-6 computed by a hierarchical latent variable variational probability computation unit 104.

The branch parameter optimization parallel processing unit 113-2 may be formed by, for example, arranging the branch parameter optimization units 106-3 according to the first exemplary embodiment in parallel, as illustrated in FIG. 15. Such a configuration allows optimization of the branch parameters for all gating function models at once.

In other words, the hierarchical latent variable model estimation devices 100 and 200 perform gating function model optimization processes one by one. The hierarchical latent variable model estimation device according to this exemplary embodiment enables more rapid estimation of model because it can perform gating function model optimization processes in parallel.

The gating function model optimization unit 113 (more specifically, the effective branch node selection unit 113-1 and the branch parameter optimization parallel processing unit 113-2) is implemented by using the CPU of a computer operating in accordance with a program (hierarchical latent variable model estimation program).

In each exemplary embodiment of the present invention, the process needs only to be substantially in parallel and, therefore, the process may be executed in simultaneously parallel or in pseud-parallel in accordance with computers executing the processes.

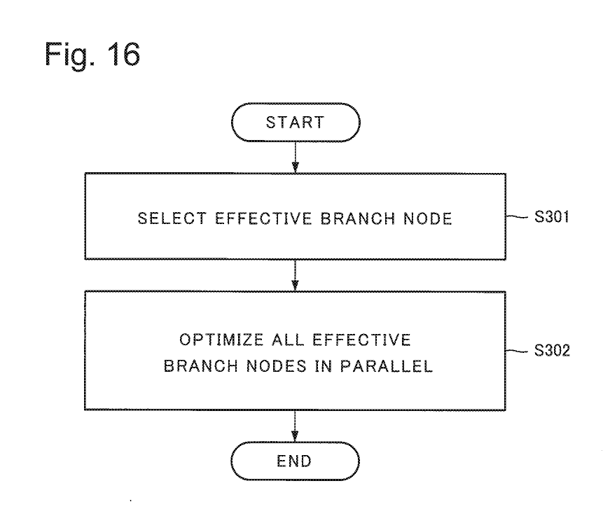

An exemplary operation of the gating function model optimization unit 113 according to this exemplary embodiment will be described below. FIG. 16 is a flowchart illustrating an exemplary operation of the gating function model optimization unit 113 according to at least one exemplary embodiment of the present invention. The effective branch node selection unit 113-1 selects all effective branch nodes first (step S301). The branch parameter optimization parallel processing unit 113-2 optimizes all the effective branch nodes in parallel and ends the process (step S302).

As described above, according to this exemplary embodiment, the effective branch node selection unit 113-1 selects an effective branch node from the nodes of the hierarchical latent structure. The branch parameter optimization parallel processing unit 113-2 optimizes the gating function model on the basis of the latent variable variational probability related to the effective branch node. In doing this, the branch parameter optimization parallel processing unit 113-2 processes optimization of each branch parameter of the effective branch node in parallel. This enables parallel processes for optimizing the gating function models and thus enables more rapid estimation of model in addition to the effects of the aforementioned exemplary embodiments.

### <<Basic Configuration>>

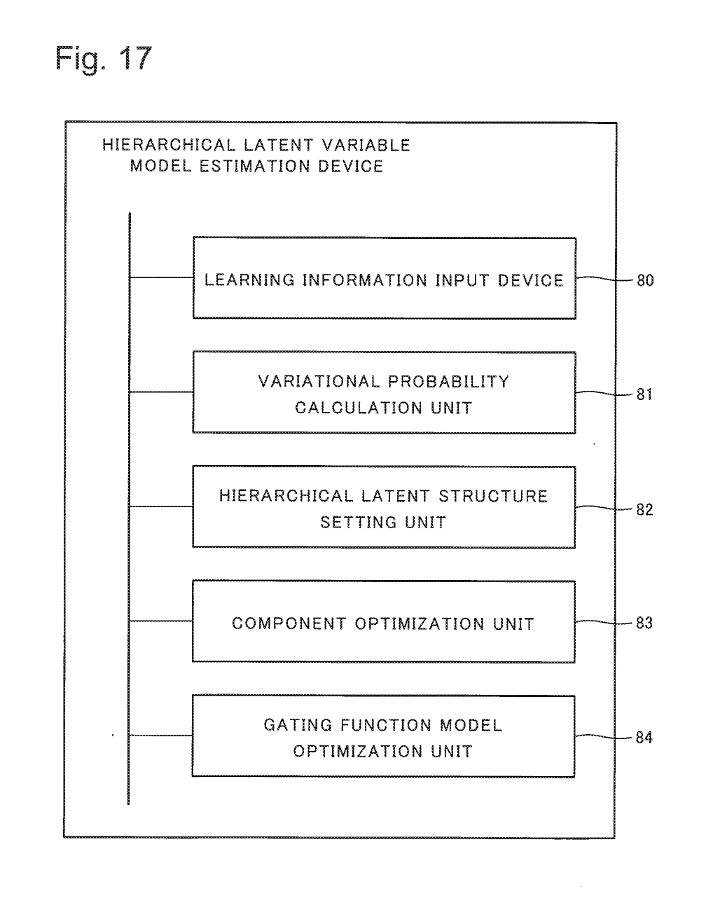

The basic configuration of a hierarchical latent variable model estimation device will be described below. FIG. 17 is a block diagram illustrating a basic configuration of a hierarchical latent variable model estimation device according to at least one exemplary embodiment of the present invention.

The hierarchical latent variable model estimation device estimates a hierarchical latent variable model for estimating an energy amount of a building and so on. The hierarchical latent variable model estimation device includes a learning information input unit 80, a variational probability calculation unit 81, a hierarchical latent structure setting unit 82 (a setting unit 82 of a hierarchical latent structure), a component optimization unit 83 (an optimization unit 83 of components) and a gating function model optimization unit 84 (an optimization unit 84 of gating function models).

The learning information input unit 80 input learning data that include a combination of a target variable of a known energy amount and at least explanatory variable that is information expected to influence an energy amount. Examples of the learning information input unit 80 may include the data input device 101.

The hierarchical latent structure setting unit 82 sets a hierarchical latent structure. In the hierarchical latent structure, latent variables are represented, for example, by a tree structure and components representing probability models are assigned to the nodes at the lowest level of the hierarchical structure. Examples of the hierarchical latent structure setting unit 82 may include the hierarchical latent structure setting unit 102.

The hierarchical latent variable variational probability computation unit 81 computes a variational probability (that is, the optimization criterion A) of path latent variables that are latent variables in a path from the root node to a target node. Examples of the hierarchical latent variable variational probability computation unit 81 may include the hierarchical latent variable variational probability computation unit 104.

The component optimization unit 83 optimizes the components for the calculated variational probability on the basis of the learning data inputted by the learning information input unit 80. Examples of the component optimization unit 83 may include the component optimization unit 105.

The gating function model optimization unit 84 optimizes the gating function models that determines a branch direction in accordance with the explanatory variable(s) at each node of the hierarchical latent structure on the basis of a latent variable variational probability at the node. Examples of the gating function model optimization unit 84 may include the gating function model optimization unit 106.

The hierarchical latent variable model estimation device including the above-mentioned configuration estimates a hierarchical latent variable model including hierarchical latent variables with an adequate amount of computation without losing theoretical justification.

The hierarchical latent variable model estimation device may include a hierarchical latent structure optimization unit (for example, the hierarchical latent structure optimization unit 201) that optimizes a hierarchical latent structure by deleting paths having a calculated variational probability that is equal or lower than a predetermined threshold. In other word, the hierarchical latent variable model estimation device may include a hierarchical latent structure optimization unit that optimizes a hierarchical latent structure by deleting paths having a calculated variational probability not satisfying a criterion. With such a configuration, a plurality of candidates for the hierarchical latent structure need not be optimized and the number of components can be optimized as well by only one execution process.

The gating function model optimization unit 84 may include an effective branch node selection unit (for example, the effective branch node selection unit 113-1) that selects effective branch nodes, that is a branch node on a path not removed from the hierarchical latent structure, from nodes in the hierarchical latent structure. The gating function model optimization unit 84 may include a branch parameter optimization parallel processing unit (for example, the branch parameter optimization parallel processing unit 113-2) that optimizes gating function models on the basis of a latent variable variational probability of the effective branch nodes. The branch parameter optimization parallel processing unit may process optimization of each branch parameter related to the effective branch nodes in parallel. Such a configuration enables more rapid estimation of model.

The hierarchical latent structure setting unit 82 may set a hierarchical latent structure having latent variables represented in a binary tree. The gating function model optimization unit 84 may optimize the gating function model based on the Bernoulli distribution on the basis of the latent variable variational probability at the node. This enables more rapid optimization because each parameter has an analytic solution.

More specifically, the hierarchical latent variable variational probability computation unit 81 may compute the latent variable variational probability so as to maximize the marginal log-likelihood.

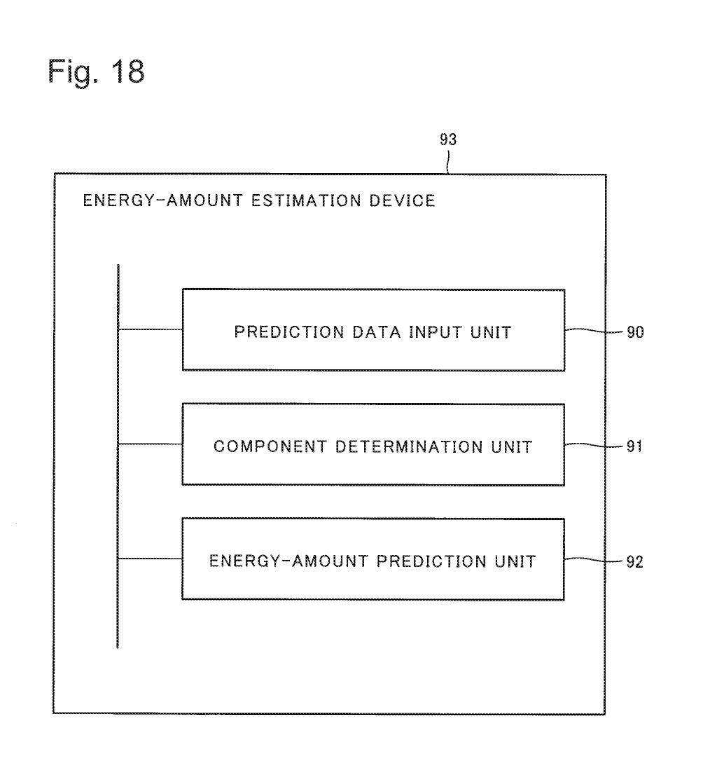

The basic configuration an energy-amount estimation device 93 will be described below. FIG. 18 is a block diagram illustrating a basic configuration of an energy-amount estimation device 93 according to at least one exemplary embodiment of the present invention.

An energy-amount prediction device 93 includes a prediction data input unit 90, a component determination unit 91, and an energy-amount prediction unit 93.

The prediction-data input unit 90 receives prediction data representing at least one explanatory variable that is information expected to influence the energy amount of a product. Examples of the prediction-data input unit 90 may include a data input device 701.

The component determination unit 91 determines components used to predict the energy amount on the basis of a hierarchical latent structure where latent variables are represented by a hierarchical structure, gating function models for selecting the branch direction at the node of the hierarchical latent structure, and the prediction data. Examples of the component determination unit 91 may include a component determination unit 703.

On the basis of the prediction data and the component selected by the component determination unit 91, the energy-amount prediction unit 92 evaluates an energy amount of a product. Examples of the energy-amount prediction unit 92 may include an energy-amount prediction unit 704.

With such a configuration, the energy amount determination device can determine an appropriate energy amount on the basis of an appropriate component selected in accordance with the gating function model.

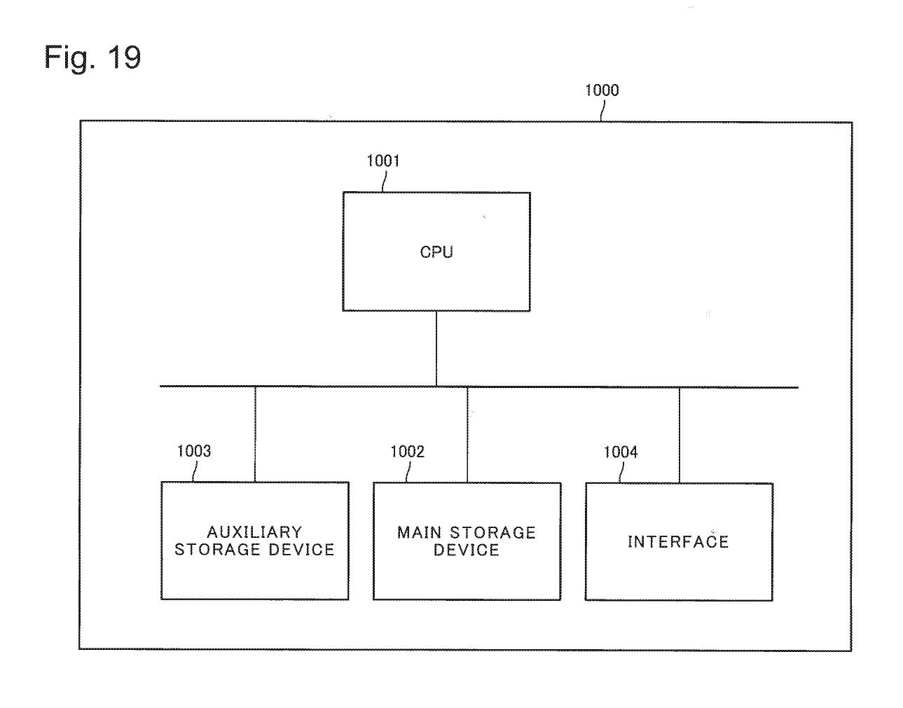

FIG. 19 is a block diagram illustrating the configuration of a computer according to at least one exemplary embodiment of the present invention.

A computer 1000 includes a CPU 1001, a main storage device 1002, an auxiliary storage device 1003, and an interface 1004.

Each of the above-mentioned hierarchical latent variable model estimation devices and energy-amount prediction devices are implemented in the computer 1000. The computer 1000 equipped with the hierarchical latent variable model estimation device may be different from the computer 1000 equipped with the energy-amount prediction device. The operation of each of the above-mentioned processing units is stored in the auxiliary storage device 1003 in the form of a program (a hierarchical latent variable model estimation program or an energy amount prediction program). The CPU 1001 reads the program from the auxiliary storage device 1003 and expands it into the main storage device 1002 to execute the above-mentioned processes in accordance with this program.

In at least one exemplary embodiment, the auxiliary storage device 1003 exemplifies a non-transitory tangible medium. Other examples of the non-transitory tangible medium may include a magnetic disk, a magneto-optical disk, a CD (Compact Disc)-ROM (Read Only Memory), a DVD (Digital Versatile Disk)-ROM, and a semiconductor memory connected via the interface 1004. When the program is distributed to the computer 1000 via a communication line, the computer 1000 may, in response to the distribution, store this program into the main storage device 1002 and execute the above-mentioned process.

The program may implement some of the above-mentioned functions. Further, the program may serve as one which implements the above-mentioned functions in combination with other programs already stored in the auxiliary storage device 1003, that is, a so-called difference file (difference program).

### Fourth Exemplary Embodiment

A fourth exemplary embodiment will be described next.

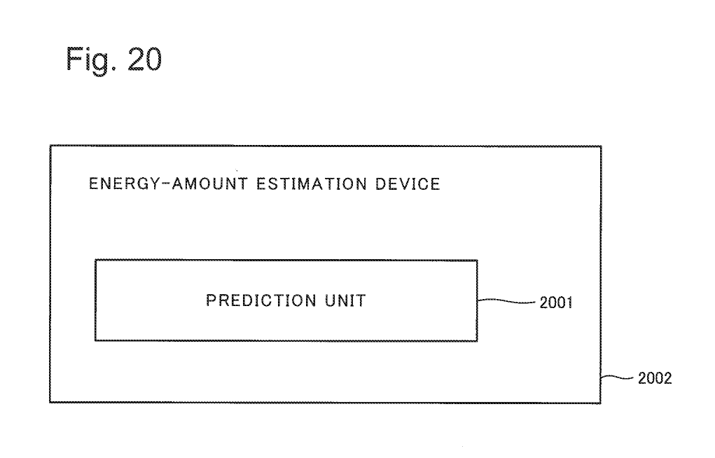

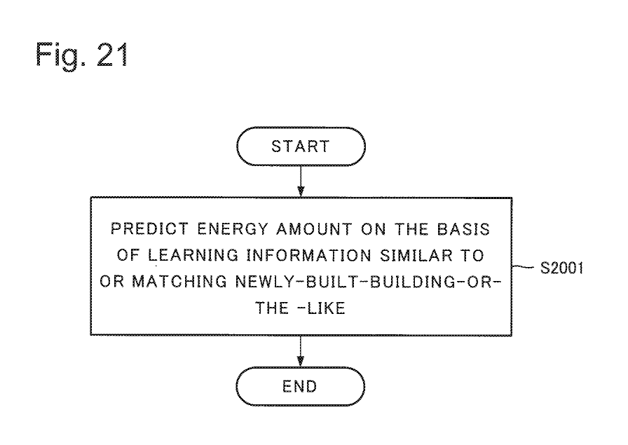

With reference to FIGS. 20 and 21, a configuration of an energy-amount estimation device 2002 according to the fourth exemplary embodiment, and processing performed by the energy-amount estimation device 2002 will be described. FIG. 20 is a block diagram illustrating a configuration of the energy-amount estimation device 2002 according to the fourth exemplary embodiment of the present invention. FIG. 21 is a flowchart illustrating a processing flow in the energy-amount estimation device 2002 according to the fourth exemplary embodiment.

The energy-amount estimation device 2002 according to the fourth exemplary embodiment includes a prediction unit 2001.

Learning information is, for example, information in which an energy amount stored in the learning database 300 exemplified in FIGS. 2A to 2F and the like are associated with one or more explanatory variables representing information potentially influencing the energy amount. The learning information may be generated, for example, on the basis of the aforementioned learning database 300 and the like. Explanatory variables related to prediction information representing a building-or-the-like being a target of energy amount prediction (hereinafter referred to as “newly-built-building-or-the-like”) is identical to explanatory variables related to the learning information. Accordingly, with respect to the learning information and the prediction information, similarity, indicating a degree of being similar to (or matching) one another, can be computed by use of an index such as a similarity index and a distance. With regard to the similarity index, the distance, and the like, various indices are already known, and therefore description is omitted in the present exemplary embodiment.

A learning algorithm such as decision tree and support vector machine is a procedure for obtaining a relation between explanatory variables and a target variable on the basis of the learning information. A prediction algorithm is a procedure for predicting an energy amount related to a newly-built-building-or-the-like on the basis of a relation computed by the learning algorithm.

First, the prediction unit 2001 predicts an energy amount related to a newly-built-building-or-the-like by applying a relation between explanatory variables and a target variable to the prediction information (Step S2001). The relation is computed on the basis of specific learning information being similar to (or matching) the prediction information in the learning information.

For example, the prediction unit 2001 may obtain the specific learning information being similar to (or matching) the prediction information on the basis of a similarity index, a distance, and the like, or may receive the specific learning information from an external device.

For convenience of description, it is hereinafter assumed in the description that the prediction unit 2001 obtains the specific learning information.

Further, the procedure for computing a relation between explanatory variables and a target variable may be a learning algorithm such as decision tree and support vector machine, or may be a procedure based on the aforementioned hierarchical latent variable model estimation device.

Processing related to the energy-amount estimation device 2002 according to the present exemplary embodiment will be described by referring to an example.

A target variable in the learning information represents, for example, an energy amount. Further, explanatory variables in the learning information represent, for example, variables include in the energy amount information as illustrated in FIG. 2A except the target variable. The learning information is, for example, information in which explanatory variables representing an existing building-or-the-like (hereinafter referred to as “existing-building-or-the-like”) are associated with an energy amount used in the existing-building-or-the-like.

The prediction unit 2001 selects specific learning information being similar to (or matching) the prediction information from the learning information. It is not necessarily required to use explanatory variables included in the learning information when obtaining specific learning information being similar to (or matching) the prediction information, and another explanatory variables may be used.

For example, when a newly-built-building-or-the-like accommodates 300 persons, the prediction unit 2001 obtains an existing-building-or-the-like accommodating a head count being similar to (or matching) 300 persons, as specific learning information.

Alternatively, when the newly-built-building-or-the-like is located in Tokyo, the prediction unit 2001 may obtain an existing-building-or-the-like located in Tokyo as specific learning information on the basis of building information illustrated in FIG. 2C and the like.

Further, the prediction unit 2001 may classify pieces of learning information into clusters by applying a clustering algorithm to the learning information, and obtain specific learning information by obtaining a cluster to which a newly-built-building-or-the-like belongs. In this case, the prediction unit 2001 selects, for example, pieces of learning information included in a cluster to which the newly-built-building-or-the-like belongs as the specific learning information.

The prediction unit 2001 obtains a relation between explanatory variables and an energy amount, in accordance with a learning algorithm, on the basis of specific learning information being similar to (or matching) the prediction information. The relation may be a linear function or a nonlinear function. For example, the prediction unit 2001 obtains a relation that a head count accommodated in an existing-building-or-the-like has a proportional relation to an energy amount in accordance with a learning algorithm.

While it is assumed in the description above that a relation between explanatory variables and a target variable is obtained on the basis of specific learning information, a mode of selecting specific learning information by selecting a specific relation from obtained relations may be employed.

Next, the prediction unit 2001 computes an energy amount by applying the obtained relation between explanatory variables and a target variable to the prediction information representing the newly-built-building-or-the-like. For example, when the newly-built-building-or-the-like accommodates 300 persons, and a head count and an energy amount are in a proportional relation, the prediction unit 2001 computes an energy amount by applying the proportional relation to the prediction information.

As described above, the energy-amount estimation device 2002 is able to predict an energy amount related to the newly-built-building-or-the-like on the basis of the learning information related to the existing-building-or-the-like.

Next, an effect that can be provided by the energy-amount estimation device 2002 according to the fourth exemplary embodiment will be described.

The energy-amount estimation device 2002 according to the fourth exemplary embodiment is able to predict an energy amount related to more newly-built-building-or-the-likes accurately.

The reason is that a learning algorithm has a property described below. That is, a learning algorithm is able to achieve high prediction accuracy by applying a relation between learning information and an energy amount to prediction information being similar to (or matching) the learning information. However, when applying the relation to prediction information not being similar to (or matching) the learning information, the learning algorithm is able to achieve only a low prediction accuracy.

The energy-amount estimation device 2002 according to the present exemplary embodiment predicts an energy amount related to a newly-built-building-or-the-like on the basis of a relation related to specific learning information being similar to (or matching) the prediction information. Accordingly, in the energy-amount estimation device 2002, the prediction information and the specific learning information are similar to (or match) one another. Consequently, the energy-amount estimation device 2002 according to the present exemplary embodiment is able to achieve a high prediction accuracy.

### Fifth Exemplary Embodiment

Next, a fifth exemplary embodiment of the present invention based on the aforementioned exemplary embodiments will be described.

In the following description, a part characteristic of the present exemplary embodiment is mainly described, and a same reference numeral is given to a similar configuration described in the aforementioned fourth exemplary embodiment, thus omitting a redundant description thereof.

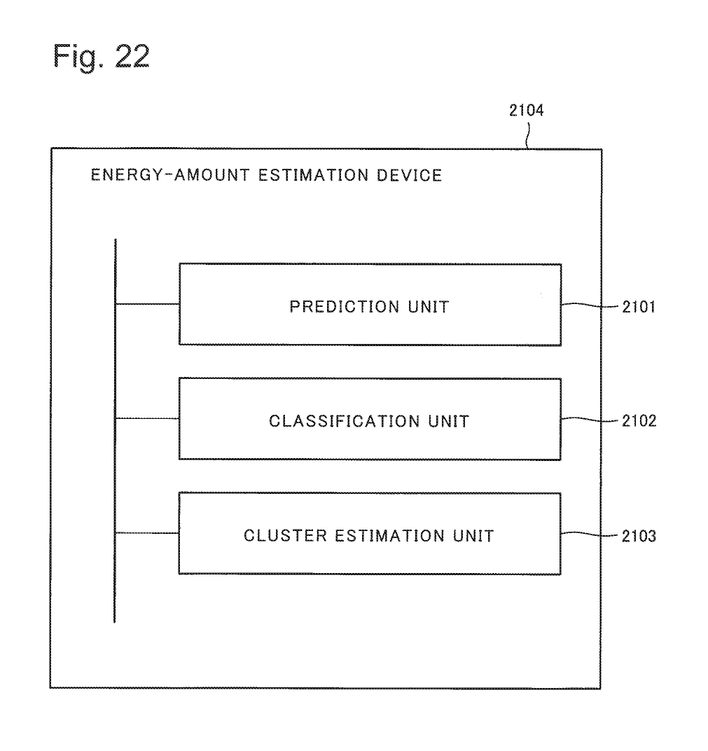

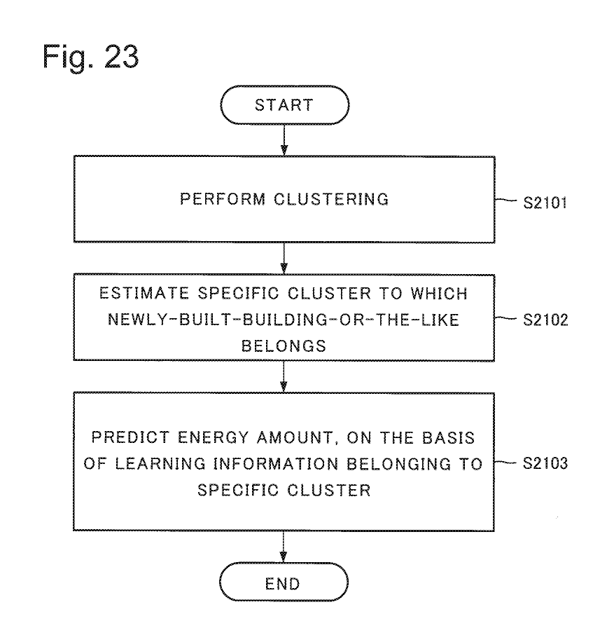

With reference to FIGS. 22 and 23, a configuration of an energy-amount estimation device 2104 according to the fifth exemplary embodiment, and processing performed by the energy-amount estimation device 2104 will be described. FIG. 22 is a block diagram illustrating a configuration of the energy-amount estimation device 2104 according to the fifth exemplary embodiment of the present invention. FIG. 23 is a flowchart illustrating a processing flow in the energy-amount estimation device 2104 according to the fifth exemplary embodiment.

The energy-amount estimation device 2104 according to the fifth exemplary embodiment includes a prediction unit 2101, a classification unit 2102, and a cluster estimation unit 2103.

A relation between explanatory variables and an energy amount in learning information can be obtained in accordance with a learning algorithm. For example, when the learning algorithm is a procedure for performing classification on the basis of explanatory variables and, then, predicting an energy amount on the basis of the classification, the algorithm divides data included in the learning information into a plurality of groups corresponding to the classification on the basis of explanatory variables. Such a learning algorithm includes an algorithm such as a regression tree, in addition to the estimation methods described in the respective exemplary embodiments of the present invention.

For convenience of description, each group is hereinafter referred to as first learning information. In other words, in this case, the learning algorithm classifies the learning information into a plurality of pieces of first learning information.

When the learning information is information related to a plurality of existing-building-or-the-likes as illustrated in FIG. 2A, the learning algorithm classifies the learning information into a plurality of pieces of first learning information related to the existing-building-or-the-likes.

First, the classification unit 2102 obtains second information representing each piece of first learning information by totalizing information included in first learning information by use of a predetermined technique. For example, the predetermined technique includes methods of randomly extracting information from first learning information, computing a mean of the first learning information by use of a distance, similarity, and the like between two pieces of information, and obtaining a center of the first learning information. The classification unit 2102 obtains second learning information by compiling the second information. The method of obtaining the second learning information is not limited to the above.

Explanatory variables in the second learning information may represent a value computed on the basis of first learning information. Alternatively, explanatory variables in the second learning information may be second explanatory variables newly added to each piece of second information included in the second learning information after the second learning information is obtained. In the following description, explanatory variables in the second learning information is referred to as second explanatory variables.

While the classification unit 2102 obtains the second learning information in the aforementioned example, the classification unit 2102 may refer to the second learning information when the second learning information has been obtained.

Next, the classification unit 2102 classifies second information included in the second learning information into a plurality of clusters on the basis of a clustering algorithm (Step S2101).

The clustering algorithm includes, for example, a non-hierarchical clustering algorithm such as a k-means algorithm, and a hierarchical clustering algorithm such as the Ward's method. A clustering algorithm is a common method and therefore description thereof is omitted in the present exemplary embodiment.

Next, the cluster estimation unit 2103 estimates a specific cluster to which a newly-built-building-or-the-like being a prediction target belongs out of a plurality of clusters on the basis of the clusters computed by the classification unit 2102 (Step S2102).

It is assumed that information representing a newly-built-building-or-the-like is expressed by use of second explanatory variables.

For example, the cluster estimation unit 2103 generates third learning information by associating second explanatory variables, representing second information in the second learning information, with an identifier (referred to as “cluster identifier”) of a specific cluster to which the second information belongs out of a plurality of clusters. In other words, the third learning information is information including second explanatory variables as explanatory variables and a specific cluster identifier as a target variable.

Next, the cluster estimation unit 2103 computes a relation between second explanatory variables and a cluster identifier by applying a learning algorithm to the third learning information. Next, the cluster estimation unit 2103 predicts a specific cluster to which the newly-built-building-or-the-like belongs by applying the computed relation to information related to the newly-built-building-or-the-like.

The cluster estimation unit 2103 may have a mode of predicting a specific cluster by performing clustering on both the learning information and prediction information.

Next, the prediction unit 2101 predicts an energy amount related to the newly-built-building-or-the-like on the basis of first learning information represented by second information belonging to the specific cluster. Specifically, the prediction unit 2101 predicts an energy amount related to the newly-built-building-or-the-like by applying a relation between explanatory variables and an energy amount to the prediction information (Step S2103). The relation is computed on the basis of the first learning information represented by the second information belonging to the specific cluster,

Next, an effect that can be provided by the energy-amount estimation device 2104 according to the fifth exemplary embodiment will be described.

The energy-amount estimation device 2104 according to the fifth exemplary embodiment is able to perform prediction with a yet higher degree of precision in addition to the effect provided by the energy-amount estimation device according to the fourth exemplary embodiment.

The reasons are, for example, a reason 1 and a reason 2. That is,

(Reason 1) A configuration of the energy-amount estimation device 2104 according to the fifth exemplary embodiment includes a configuration of the energy-amount estimation device according to the fourth exemplary embodiment.

(Reason 2) A clustering algorithm is a technique for classifying a set into a plurality of clusters. Accordingly, the clustering algorithm is able to perform overall classification more precisely, in contrast to a technique of computing learning information similar to a newly-built-building-or-the-like, solely on the basis of similarity. In other words, the cluster estimation unit 2103 is able to predict a cluster being more similar to prediction information. Consequently, the prediction unit 2101 predicts an energy amount related to the newly-built-building-or-the-like on the basis of learning information being more similar to the prediction information, and therefore is able to predict an energy amount with a yet higher accuracy.

### Sixth Exemplary Embodiment

Next, a sixth exemplary embodiment of the present invention based on the aforementioned exemplary embodiments will be described.

In the following description, a part characteristic of the present exemplary embodiment is mainly described, and a same reference numeral is given to a similar configuration described in the aforementioned fifth exemplary embodiment, thus omitting a redundant description thereof.

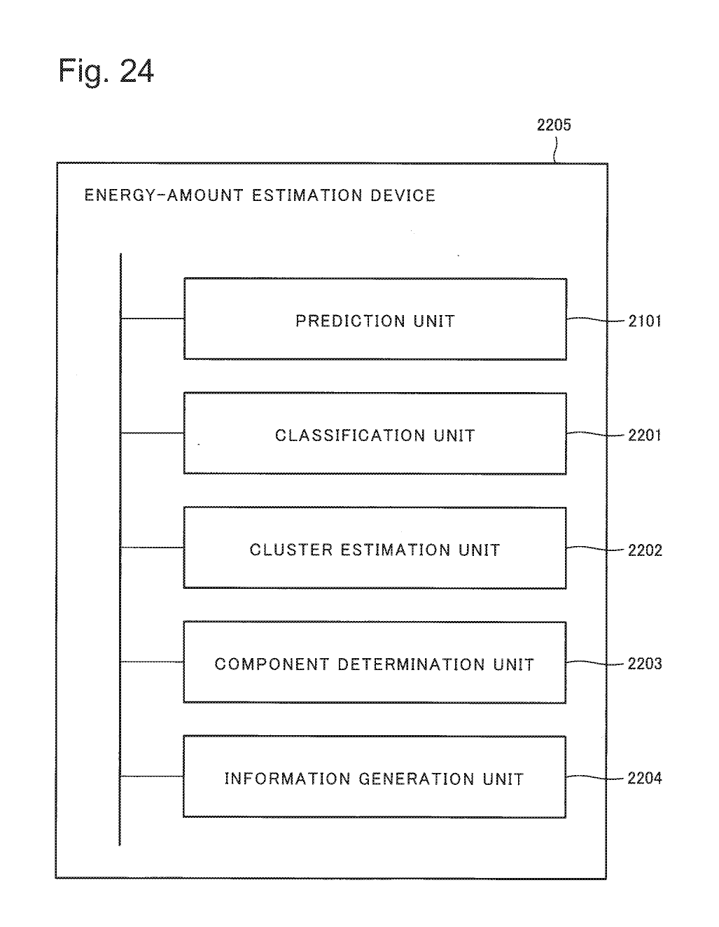

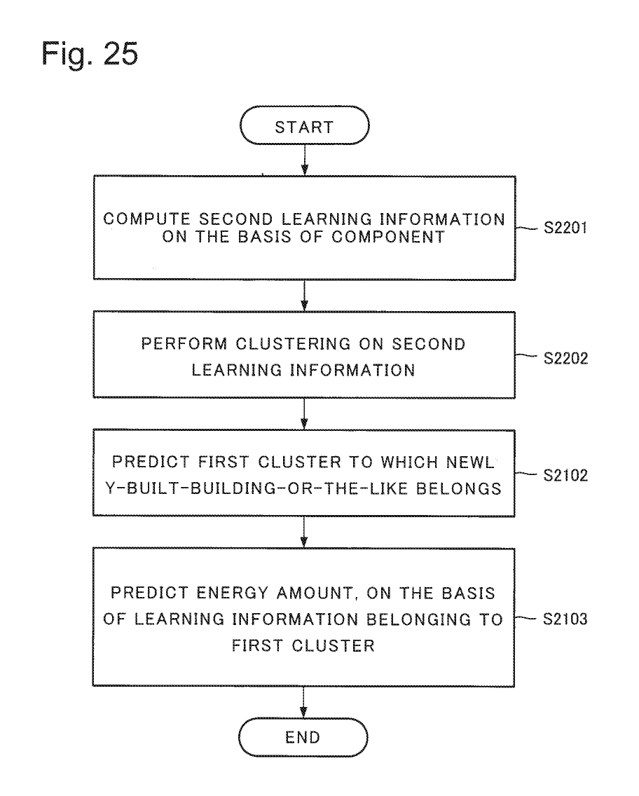

With reference to FIGS. 24 and 25, a configuration of an energy-amount estimation device 2205 according to the sixth exemplary embodiment, and processing performed by the energy-amount estimation device 2205 will be described. FIG. 24 is a block diagram illustrating a configuration of the energy-amount estimation device 2205 according to the sixth exemplary embodiment of the present invention. FIG. 25 is a flowchart illustrating a processing flow in the energy-amount estimation device 2205 according to the sixth exemplary embodiment.

The energy-amount estimation device 2205 according to the sixth exemplary embodiment includes a prediction unit 2101, a classification unit 2201, a cluster estimation unit 2202, a component determination unit 2203, and an information generation unit 2204.

The component determination unit 2203 is any one of the component determination units 2203 according to the aforementioned first to third exemplary embodiments.

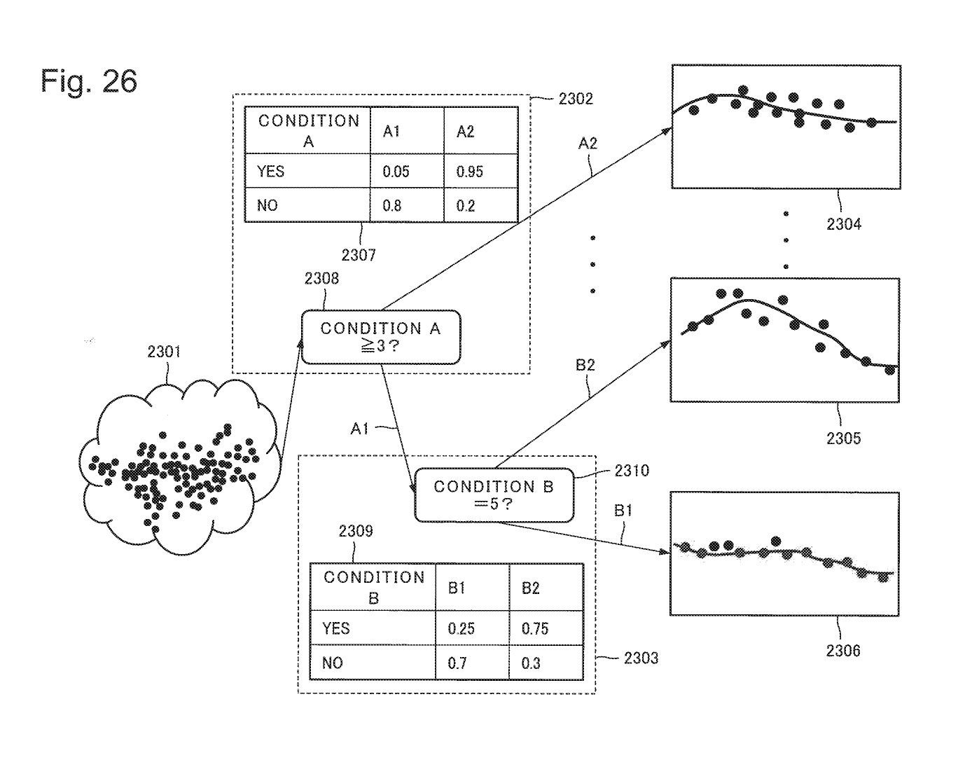

In other words, the component determination unit 2203 computes a gating function model and a component as illustrated in FIG. 26 for each existing-building-or-the-like, on the basis of learning information 2301. FIG. 26 is a diagram illustrating an example of gating function models and components generated by the component determination unit 2203 according to at least one of the exemplary embodiments of the present invention.

For example, when a latent variable model has a tree structure, the latent variable model has a tree structure as exemplified in FIG. 26. A condition related to a specific explanatory variable (a random variable in this case) is allocated to each node (nodes 2302 and 2303) in the tree structure. For example, the node 2302 represents a condition related to whether or not a value of explanatory variables A is greater than or equal to 3 (condition information 2308). Similarly, the node 2303 represents a condition related to whether or not a value of explanatory variables B is equal to 5 (condition information 2310).

A probability (probability information 2307 and 2309) related to selection of next branch node or next component based on a value of an explanatory variable is allocated to the explanatory variable.

For example, it is assumed that, at the node 2302, when a value of the explanatory variable A is greater than or equal to 3 (that is, YES in the condition information 2308), the probability of selecting a branch A1 is 0.05 and the probability of selecting a branch A2 is 0.95 on the basis of the probability information 2307. It is further assumed that, when a value of the explanatory variable A is less than 3 (that is, NO in the condition information 2308), the probability of selecting the branch A1 is 0.8 and the probability of selecting the branch A2 is 0.2 on the basis of the probability information 2307.

Similarly, for example, it is assumed that, at the node 2303, when a value of the explanatory variable B is equal to 5 (that is, YES in the condition information 2310), the probability of selecting a branch B1 is 0.25 and the probability of selecting a branch B2 is 0.75 on the basis of the probability information 2309. It is further assumed that, when a value of the explanatory variable B is not equal to 5 (that is, NO in the condition information 2310), the probability of selecting the branch B1 is 0.7 and the probability of selecting the branch B2 is 0.3 on the basis of the probability information 2309.

For convenience of description, it is assumed that the value of the explanatory variable A is 4, and the value of the explanatory variable B is 7.

In this case, the value of the explanatory variable A is greater than or equal to 3, and therefore the probability of selecting the branch A1 is 0.05 and the probability of selecting the branch A2 is 0.95. The value of the explanatory variable B is not equal to 5, and therefore the probability of selecting the branch B1 is 0.7 and the probability of selecting the branch B2 is 0.3. In other words, the probability of a model being a component 2306 is 0.05×0.7=0.035 as the component 2306 is reachable via the branches A1 and B1. The probability of the model being a component 2305 is 0.05×0.3=0.015 as the component 2305 is reachable via the branches A1 and B2. The probability of the model being a component 2304 is 0.95 as the component 2304 is reachable via the branch A2. Thus, the probability of the model being the component 2304 is maximum, and therefore the prediction unit 2101 predicts an energy amount related to a newly-built-building-or-the-like in accordance with the component 2304.

While a case that a latent variable model has a tree structure has been described in the aforementioned example, even in a case that a latent variable model has a hierarchical structure, a probability related to a component is computed by use of a gating function model, and a component having the maximum probability is selected.

The component determination unit 2203 determines a gating function model and a component in advance on the basis of the learning information in accordance with the procedure according to the first to third exemplary embodiments.

First, the information generation unit 2204 computes second learning information on the basis of the learning information and on the basis of a component determined by the component determination unit 2203 (Step S2201). The information generation unit 2204 computes the second learning information, on the basis of a parameter included in the component.

For example, the information generation unit 2204 reads a parameter related to the component determined by the component determination unit 2203. For example, when the component is a linear regression, the information generation unit 2204 reads a weight related to a variable as a parameter. Further, when the component is a Gaussian distribution, the information generation unit 2204 reads a mean and a variance characterizing the Gaussian distribution as parameters. The component is not limited to the aforementioned model.

Next, the information generation unit 2204 aggregates the read parameters for each existing-building-or-the-like.

For convenience of description, it is assumed that components are components 1 to 4. Specifically,

(Component 1) A component capable of predicting an energy amount of a building A in a period from 0 to 6 o'clock,

(Component 2) A component capable of predicting an energy amount of the building A in a period from 6 to 12 o'clock,

(Component 3) A component capable of predicting an energy amount of the building A in a period from 12 to 18 o'clock, and

(Component 4) A component capable of predicting an energy amount of the building A in a period from 18 to 24 o'clock.

In this case, the information generation unit 2204 reads a parameter 1 from the component 1. Similarly, the information generation unit 2204 reads parameters 2 to 4 from the components 2 to 4, respectively.

Next, the information generation unit 2204 aggregates the parameters 1 to 4. The aggregation method is, for example, a method of computing a mean of parameters of a same type in the parameters 1 to 4. Further, when the component is a linear regression, the aggregation method is a method of computing a mean of coefficients related to a certain variable. The aggregation method is not limited to a method of computing a mean, and may be a method of, for example, computing a median. In other words, the aggregation method is not limited to the aforementioned example.

Next, the information generation unit 2204 aggregates the parameters for each existing-building-or-the-like. Then, the information generation unit 2204 computes the second learning information with the aggregated parameters as explanatory variables.

Next, by performing clustering on the second learning information computed by the information generation unit 2204, the classification unit 2201 computes a cluster number related to the generated second learning information (Step S2101).

Next, the cluster estimation unit 2202 estimates a cluster number to which the newly-built-building-or-the-like belongs (Step S2102).

In this case, the cluster estimation unit 2202 first computes third learning information by associating second explanatory variables with a cluster number, with respect to the target of the cluster number computation. Next, the cluster estimation unit 2202 computes a relation between second explanatory variables and a cluster number in the third learning information by applying a learning algorithm to the third learning information. Then, the cluster estimation unit 2202 predicts a cluster number related to the prediction information on the basis of the computed relation.

For convenience of description, the cluster number is hereinafter referred to as a first cluster.

Next, the prediction unit 2101 reads learning information belonging to the first cluster in the second learning information. Then, the prediction unit 2101 predicts a value of a target variable (energy amount in this example) with respect to the newly-built-building-or-the-like on the basis of a gating function model and a component related to the read learning information (Step S2103).

Next, an effect that can be provided by the energy-amount estimation device 2205 according to the sixth exemplary embodiment will be described.

The energy-amount estimation device 2205 according to the sixth exemplary embodiment is able to perform prediction more accurately, in addition to the effect that can be provided by the energy-amount estimation device according to the fourth exemplary embodiment.

The reasons are, for example, two reasons, a reason 1 and a reason 2, described below. That is,

(Reason 1) A configuration of the energy-amount estimation device 2205 according to the sixth exemplary embodiment includes a configuration of the energy-amount estimation device according to the fifth exemplary embodiment.

(Reason 2) The information generation unit 2204 is able to analyze a relation between explanatory variables and a target variable by analyzing a parameter in a component. Specifically, the information generation unit 2204 is able to extract explanatory variables (parameters) being a main factor for explaining a target variable (energy amount in this case) in first learning information by analyzing a parameter in a component related to the first learning information.

Subsequently, the classification unit 2201 classifies learning information on the basis of the parameter being the main factor for explaining an energy amount. Consequently, the generated cluster is a cluster based on the main factor (explanatory variable) for explaining an energy amount. Thus, the aforementioned processing meets an object of predicting an energy amount related to a newly-built-building-or-the-like, and therefore is able to perform clustering based on the main factor for explaining an energy amount more accurately.

Subsequently, the prediction unit 2101 estimates that the main factor for explaining an energy amount related to the newly-built-building-or-the-like is similar to the selected existing-building-or-the-like by selecting an existing-building-or-the-like belonging to a same cluster as the newly-built-building-or-the-like. Subsequently, the prediction unit 2101 applies a gating function model and a component related to the selected existing-building-or-the-like to prediction information. Accordingly, the prediction unit 2101 predicts an energy amount related to the newly-built-building-or-the-like by use of the gating function model and the component with a similar (or matching) main factor related to an energy amount. Therefore, the energy-amount estimation device 2205 according to the present exemplary embodiment achieves high prediction accuracy.

The energy-amount estimation device according to the respective aforementioned exemplary embodiments may be used in, for example, an electric-power management system for predicting an electric-power demand, and planning one or more of electric-power procurement, electric-power generation, electric-power purchase, and electric-power saving, on the basis of the predicted electric-power demand.

Additionally, an electric-power production amount such as photovoltaic power generation may be predicted and the predicted electric-power production amount may be added to an input of the electric-power management system.

Furthermore, the device may be used for devising a low-cost heat production plan, by, for example, predicting a thermal demand amount in a building or a region.

The present invention has been described above by taking the above-described exemplary embodiments as exemplary examples. However, the present invention is not limited to the above-described exemplary embodiments. In other words, the present invention can adopt various modes which would be understood by those skilled in the art without departing from the scope of the present invention.

This application claims priority based on U.S. Patent 61/971,592 filed on Mar. 28, 2014, the disclosure of which is incorporated herein by reference in its entirety.

### REFERENCE SIGNS LIST

10: energy-amount prediction system
100: hierarchical latent variable model estimation device
500: model database
700: energy-amount estimation device
111: input data
101: data input device
102: hierarchical latent structure setting unit
103: initialization unit
104: hierarchical latent variable variational probability computation unit
105: component optimization unit
106: gating function model optimization unit
107: optimality determination unit
108: optimal model selection unit
109: model estimation result output device
112: model estimation result
104-1: lowest-level path latent variable variational probability computation unit
104-2: hierarchical setting unit
104-3: higher-level path latent variable variational probability computation unit
104-4: hierarchical computation end determination unit
104-5: estimated model
104-6: hierarchical latent variable variational probability
106-1: branch node information acquisition unit
106-2: branch node selection unit
106-3: branch parameter optimization unit
106-4: total branch node optimization end determination unit
106-6: gating function model
701: data input device
702: model acquisition unit
703: component determination unit
704: energy-amount prediction unit
705: prediction result output device
711: input data
712: prediction result
200: hierarchical latent variable model estimation device
201: hierarchical latent structure optimization unit
201-1: path latent variable summation operation unit
201-2: path removal determination unit
201-3: path removal execution unit
113: gating function optimization unit
113-1: effective branch node selection unit
113-2: branch parameter optimization parallel processing unit
80: learning information input device
81: variational probability calculation unit
82: hierarchical latent structure setting unit
83: component optimization unit
84: gating function model optimization unit
90: prediction-data input unit
91: component determination unit
92: shipment-volume prediction unit
93: order-volume determination unit
1000: computer
1001: CPU
1002: main storage device
1003: auxiliary storage device
1004: interface
2001 Prediction unit
2002 Energy-amount estimation device
2101 Prediction unit
2102 Classification unit
2103 Cluster estimation unit
2104 Energy-amount estimation device
2201 Classification unit
2202 Cluster estimation unit
2203 Component determination unit
2204 Information generation unit
2205 Energy-amount estimation device
2301 Learning information
2302 Node
2303 Node
2304 Component
2305 Component
2306 Component
2307 Probability information
2308 Condition information
2309 Probability information
2310 Condition information

What is claimed is:

1. An energy-amount estimation device comprising:
a prediction data input unit configured to input prediction data being one or more explanatory variables potentially influencing an energy amount;
a component determination unit configured to determine a component used for prediction of the energy amount on the basis of:
a hierarchical latent structure in which a latent variable is expressed by a hierarchical structure which includes (i) one or more nodes arranged at each level of the hierarchical structure, (ii) a path between a node arranged at a first level and a node arranged at a subordinate second level, and (iii) components representing a probability model arranged in a node at a lowest level of the hierarchical structure,
a gating function model being a basis of determining the path between the nodes constituting the hierarchical latent structure when determining the component, and
the prediction data; and
an energy-amount prediction unit configured to predict the energy amount on the basis of the component determined by the component determination unit and the prediction data.

2. The energy-amount estimation device according to claim 1, further comprising:
an optimization unit configured to optimize the hierarchical latent structure by excluding the path with a variational probability, that represents a probability distribution of the latent variable, not meeting a criterion from a processing target on which optimization processing is performed in the hierarchical latent structure.

3. The energy-amount estimation device according to claim 2, further comprising:
an optimization unit including:
a selection unit configured to select an effective branch node, that represents a branch node not excluded from the hierarchical latent structure, in the path, out of nodes in the hierarchical latent structure, and
a parallel processing unit configured to optimize the gating function model on the basis of the variational probability of the latent variable in the effective branch node, wherein
the parallel processing unit performs parallel optimization processing on each branch parameter related to the effective branch node.

4. The energy-amount estimation device according to claim 1, further comprising:
a setting unit configured to set the hierarchical latent structure in which the latent variable is expressed by use of a binary tree structure; and
an optimization unit configured to optimize the gating function model based on a Bernoulli distribution on the basis of a variational probability representing a probability distribution of the latent variable in each node.

5. The energy-amount estimation device according to claim 1, further comprising:
a variational probability computation unit configured to compute a variational probability representing a probability distribution of the latent variable so as to maximize a marginal log likelihood.

6. An energy-amount estimation device comprising:
a prediction unit configured to predict an energy amount related to prediction information on the basis of a relation, that is computed based on specific learning information being similar to or matching the prediction information being a prediction target in learning information associated with a target variable representing the energy amount and one or more of explanatory variables representing information potentially influencing the energy amount, between the explanatory variables and the energy amount.

7. The energy-amount estimation device according to claim 6, further comprising:
a classification unit configured to compute second learning information representing a plurality of pieces of first learning information into which the learning information is classified, and classifying the computed second learning information into a plurality of clusters; and
a cluster estimation unit configured to select a specific cluster to which the prediction information belongs out of the plurality of clusters, wherein
the prediction unit predicts the energy amount by use of the first learning information represented by the second learning information belonging to the specific cluster.

8. The energy-amount estimation device according to claim 7, wherein
the cluster estimation unit generates a second relation holding between second explanatory variables and a cluster identifier on the basis of third learning information where the second explanatory variables representing the second learning information are associated with the cluster identifier identifying the plurality of clusters, and estimates the specific cluster by applying the second relation to the second explanatory variables representing the prediction information.

9. The energy-amount estimation device according to claim 7, further comprising:
a component determination unit configured to determine a component used for prediction of the energy amount on the basis of a hierarchical latent structure being a structure in which a latent variable is expressed by a hierarchical structure which includes one or more nodes arranged at each level of the hierarchical structure, includes a path between a node arranged at a first level and a node arranged at a subordinate second level and includes components representing a probability model are arranged in a node at a lowest level of the hierarchical structure, a gating function model being a basis for determining the path between nodes constituting the hierarchical latent structure when determining the component, and the prediction information; and
an information generation unit configured to compute the second learning information on the basis of the first learning information and the component, wherein
the classification unit performs classification into the plurality of clusters on the basis of the second learning information computed by the information generation unit.

10. The energy-amount estimation device according to claim 9, wherein
the information generation unit computes the second learning information by performing totalization with respect to a parameter included in the component related to the first learning information.

11. An energy-amount estimation method comprising, by use of an information processing device:
inputting prediction data being one or more explanatory variables potentially influencing an energy amount;
determining a component used for prediction of the energy amount on the basis of:
a hierarchical latent structure in which a latent variable is expressed by a hierarchical structure which includes (i) one or more nodes arranged at each level of the hierarchical structure, (ii) a path between a node arranged at a first level and a node arranged at a subordinate second level, and (iii) components representing a probability model arranged in a node at a lowest level of the hierarchical structure,
a gating function model being a basis of determining the path between the nodes constituting the hierarchical latent structure when determining the component, and
the prediction data; and
predicting the energy amount on the basis of the determined component and the prediction data.

12. A non-transitory recording medium storing an energy-amount estimation program causing a computer to provide:
a prediction data input function configured to input prediction data being one or more explanatory variables potentially influencing an energy amount;
a component determination function configured to determine a component used for prediction of the energy amount on the basis of:
a hierarchical latent structure in which a latent variable is expressed by a hierarchical structure which includes (i) one or more nodes arranged at each level of the hierarchical structure, (ii) a path between a node arranged at a first level and a node arranged at a subordinate second level, and (iii) components representing a probability model arranged in a node at a lowest level of the hierarchical structure,
a gating function model being a basis of determining the path between the nodes constituting the hierarchical latent structure when determining the component, and
the prediction data; and
an energy-amount prediction function configured to predict the energy amount on the basis of the determined component and the prediction data.
